(19) United States
(12) Patent Application Publication
(10) Pub. No.: US 2023/0255219 A1
(43) Pub. Date: Aug. 17, 2023

(54) SLOW RELEASE COMPOSITE ACTIVE FILMS/PACKAGING TO REDUCE FOODBORNE PATHOGENS AND IMPROVE SHELF LIFE OF RAW AND READY TO EAT FOODS

(71) Applicant: The Penn State Research Foundation, University Park, PA (US)

(72) Inventors: Catherine N. CUTTER, State College, PA (US); Abdelrahim H.A. HASSAN, Beni-Suef (EG)

(21) Appl. No.: 17/780,716

(22) PCT Filed: Nov. 24, 2020
(86) PCT No.: PCT/US2020/062057

§ 371 Date: May 27, 2022

Related U.S. Application Data
(60) Provisional application No. 63/040,468, filed on Jun. 17, 2020.
(60) Provisional application No. 62/941,281, filed on Nov. 27, 2019.

(51) Int. Cl. A23B 4/20

(52) U.S. Cl. CPC A23B 4/20

(57) ABSTRACT

Provided are composite antimicrobial and laminar antimicrobial materials that are suitable for use with food packaging. The materials may be edible, recyclable, or biodegradable materials. Methods for making the materials, uses of the materials, and products that pertain to the materials are included.

### CROSS-REFERENCE TO RELATED APPLICATIONS

This application claims priority to U.S. provisional patent application No. 62/941,281, filed Nov. 27, 2019, and to U.S. provisional patent application No. 63/040,468, filed Jun. 17, 2020, the disclosures of each of which are incorporated herein by reference.

### STATEMENT REGARDING FEDERALLY SPONSORED RESEARCH

This invention was made with government support under Hatch Act Project No. PEN04666 awarded by the United States Department of Agriculture. The government has certain rights in the invention.

### FIELD

The present disclosure relates generally to improved compositions, materials, and products used for controlling growth of bacteria on food products.

### BACKGROUND

The application of materials to control the growth of foodborne pathogens in foods could provide an increased margin of safety during long-term refrigerated storage of both raw and ready-to-eat (RTE) foods (Mangalassary et al. 2008). One method to reduce microbial growth and extend the shelf-life of foods is the use of antimicrobial food packaging. Along with efforts to avoid public health risks of foodborne pathogens and to extend the shelf-life of foods, global attention has focused on reducing plastic waste to protect our planet. Therefore, natural biocompatible, recyclable and edible films and coatings made of polysaccharides, proteins or lipids have received attention in recent years (Debeaufort et al., 1998; Guilbert et al., 1996). Moreover, consumers are interested in natural food packaging materials (Trinetta et al., 2010). Nevertheless, replacing plastic food packaging using stand-alone biodegradable films represents a difficult task to achieve, given their failure to maintain functional and structural integrity over time, particularly due to poor mechanical strength and dissolvability of such bio-based films when in contact with water (Tharanathan, 2003). Thus, there is an ongoing and unmet need for improved food packaging materials. The present disclosure is pertinent to this need.

### SUMMARY

The present disclosure provides in certain embodiments composite antimicrobial or laminar materials that are suitable for use with food packaging. In embodiments, the materials are at least one of: edible, recyclable, or biodegradable materials. In embodiments, the material comprises one or more polymers, including but not necessarily limited to biopolymers, and copolymers. Methods for making the described materials, and uses and products that pertain to the described materials are included.

In embodiments, the disclosure includes an antimicrobial material for use in food packaging, the antimicrobial material comprising: i) a first layer comprising one or more polysaccharides or polysaccharide biopolymers comprising an effective amount of at least one antimicrobial agent; and ii) a second layer comprising a polyethylene or a chitosan. At least a first portion of the first layer is disposed on at least a portion of the second layer. In non-limiting embodiments, all of the first layer is disposed on all of the second layer. In embodiments, the second layer comprise polyethylene, which may also comprise additional agents, one non-limiting example of which is ethylene vinyl alcohol (EVOH). In embodiments, the polyethylene layer provides flexibility and sealability during vacuum packaging of foods. In embodiments, the at least one antimicrobial agent is lauric arginate (LAE), which is demonstrated herein to be more effective than other tested agents, which exhibit little or insufficient antimicrobial activity when included in the described materials. In embodiments, the antimicrobial agent is present in a layer that comprises pullulan (Pu) or chitosan. In embodiments, the first layer is adhered to the second layer. One or both layers may comprise a film. In embodiments, at least a portion of the first layer is in contact with a food product. In embodiments, the described contact with the food product inhibits growth of bacteria on or within the food product, or reduced the amount of bacteria on the food product, relative to the amount of bacteria present before contacting the food product with the described material. Gram-positive and Gram-negative bacteria are included in those that are inhibited in their growth, and/or are reduced. In embodiments, growth of bacteria is inhibited for a period of at least 14 days under refrigeration conditions, non-limiting examples of said effects on bacteria are provided in tables of this disclosure.

The disclosure includes a method of making the described antimicrobial material for use in food packaging. The method comprises a) combining an effective amount of at least one antimicrobial agent with one or more polysaccharides or polysaccharide biopolymers to form an antimicrobial composition for forming a first layer in the antimicrobial material. The first layer is contacted with a second layer comprising a polyethylene or a chitosan. The method results in an antimicrobial material comprising the first layer and the second layer for use in food packaging. In embodiments, the second layer is subjected to ultraviolet radiation prior to contacting the antimicrobial composition with the second layer. The method can include applying the antimicrobial material comprising the first layer and the second layer to a food product.

In an embodiment, the disclosure includes a method of increasing the shelf life of a food product and/or inhibiting growth of bacteria in the food product. The method comprises packaging the food product with an antimicrobial material comprising i) a first layer comprising one or more polysaccharides or polysaccharide biopolymers comprising an effective amount of at least one antimicrobial agent; and ii) a second layer comprising a polyethylene or a chitosan, as described above. Any antimicrobial materials made by the described methods are also included in the disclosure.

In embodiments, the disclosure thus provides composite antimicrobial films (CAFs) laminated antimicrobial films (LAFs) that represent improved materials for use in food packaging.

In developing embodiments of the present disclosure, initially, CAFs were developed by incorporating thymol (T), nisin (N) and/or lauric arginate (LAE) into a pullulan layer and layering it on top of polyethylene (PE). The antimicrobial activity of the resulting CAFs was evaluated against cocktails of Shiga toxin-producing E. coli (STEC), Salmonella spp., Listeria monocytogenes (L. monocytogenes) and Staphylococcus aureus (S. aureus) in disk diffusion assays (DDAs). CAFs containing N were ineffective, while those containing T were effective for inhibiting the pathogens in DDAs. However, T containing CAFs did not exhibit desirable physical and mechanical properties since solvents (HC1 and ethanol, respectively) interfered with the binding of pullulan to PE. Conversely, CAFs made with 0.5, 1 and 2.5% LAE maintained proper physical and mechanical characteristics and inhibited the four bacterial pathogens in DDAs. Based on these results, cocktails containing Shiga toxin producing E. coli (STEC), Salmonella, L. monocytogenes, or S. aureus were inoculated onto raw beef, raw chicken breast, or ready-to-eat (RTE) turkey breast that were made into sachets/bags, vacuum packaged, sealed, and remaining microbial populations determined during refrigerated storage. The results demonstrate that the materials have suitable mechanical, optical, and antimicrobial properties for use in food packaging. Similar results were obtained using LAFs. Thus, the presently provided materials are pertinent to, among other uses, meat and poultry industry to control foodborne pathogens associated with these food products.

### BRIEF DESCRIPTION OF THE DRAWINGS

FIG. 1: Resazurin indicator-based, 96-well microplate dilution method for determination of minimum inhibitory concentration (MIC) of antimicrobials against different bacterial cocktails.

FIG. 2. Log reductions of: A) STEC cocktail (log₁₀ CFU/cm²) experimentally-inoculated onto raw beef slices; B) Salmonella cocktail (log₁₀ CFU/cm²) experimentally-inoculated onto raw chicken meat slices; C) Listeria monocytogenes cocktail (log₁₀ CFU/cm²) experimentally-inoculated onto turkey breast slices; and D) Staphylococcus aureus cocktail (log₁₀ CFU/cm²) experimentally-inoculated onto turkey breast slices, vacuum packaged in sachets/bags made of composite antimicrobial films (CAF) containing different LAE concentration (0.5, 1 or 2.5%) and refrigerated storage (4° C.) up to 28 days. Log reduction was calculated by subtracting the remaining count means in CAF from remaining count means in control films.

FIG. 3. Chart A) Thickness (T, μm) and chart B) Transparency (Tr, %) of different film types; polyethylene (PE), pullulan (Pu), pullulan-polyethylene laminate (Pu/PE), and laminated antimicrobial films with various lauric arginate concentrations (LAF/LAE 0.5, 1.0 or 2.5%). Data are represented by means of at least 5 replicates ±standard deviations. Different letters (a, b, c, d) indicate significant differences between means (p<0.05).

FIG. 4. Photo of vacuum packaged: A) raw beef and B) ready-to-eat turkey breast deli meat in a heat-sealed sachet made from a laminated antimicrobial film (LAF) consisting of 2.5% (v/v) lauric arginate (LAF/LAE 2.5%).

FIG. 5. Chart A) Ultimate tensile strength (TS, MPa), chart B) Elongation at the break (EB, %) and chart C) Elastic modulus (EM, g/mm²) of different types of film; polyethylene (PE), pullulan (Pu), pullulan-polyethylene laminate (Pu/PE), and laminated antimicrobial films with various lauric arginate concentrations (LAF/LAE 0.5, 1.0 or 2.5%). Data are represented by means of at least 5 replicates ±standard deviations. Different letters (a, b, c, d) indicate significant differences between means (p<0.05).

FIG. 6. Chart A) Puncture resistance (PR, N) and chart B) Deformation at the puncture (DP, mm) of different types of films; polyethylene (PE), pullulan (Pu), pullulan-polyethylene laminate (Pu/PE), and laminated antimicrobial films with various lauric arginate concentrations (LAF/LAE 0.5, 1.0 or 2.5%). Data are represented by means of at least 5 replicates±standard deviations. Different letters (a, b, c, d) indicate significant differences between means (p<0.05).

FIG. 7. Zone of inhibition against foodborne pathogens: Staphylococcus aureus, Listeria monocytogenes, Salmonella spp. and Shiga toxin producing E. coli (STEC) caused by LAFs with different concentrations of LAE and control films. Data are represented by means of at least 3 replicates±standard deviations.

### DETAILED DESCRIPTION

Unless defined otherwise herein, all technical and scientific terms used in this disclosure have the same meaning as commonly understood by one of ordinary skill in the art to which this disclosure pertains.

Every numerical range given throughout this specification includes its upper and lower values, as well as every narrower numerical range that falls within it, as if such narrower numerical ranges were all expressly written herein.

Any result obtained using a method described herein can be compared to any suitable reference, such as a known value, or a control sample or control value, suitable examples of which will be apparent to those skilled in the art, given the benefit of this disclosure.

All methods of making the compositions, materials, and products described herein are included in the disclosure.

The disclosure includes all materials described herein, and all mechanical and physical properties of the material, including but not necessarily limited to effectiveness in preventing bacterial growth, effectiveness in inhibiting bacterial growth, lengths of time during which effects to bacteria are maintained, compound release rates, thickness, tensile strength, elastic modulus, elongation at break, puncture resistance, deformity at puncture, as well as heat-sealability, transparency, and all combinations thereof. In embodiments, a material provided by the disclosure is essentially colorless, odorless in respect of human olfactory capabilities, tasteless in respect of human sense of taste, is partially or fully transparent, or a combination thereof. In embodiments, a material of this disclosure comprises or consists of any combination of materials described herein. In embodiments, a material of this disclosure comprises or consists of a composite film, as further described herein. In embodiments, the composite film comprises or consists of a polysaccharide (e.g., polysaccharide biopolymer) film disposed on a least a portion of a surface of the polyethylene and/or chitosan film, and may comprise one or more antimicrobial agents, and other components as described herein. In embodiments, a product provided by this disclosure improves shelf life of a packaged food product, and/or preserves color and/or freshness of the food product, relative to a food product contained or otherwise packaged and in physical contact with a different material. In embodiments, a material or portion thereof provided by this disclosure is biodegradable. In embodiments, the disclosure thus includes an antimicrobial material for use in food packaging, the antimicrobial material comprising: i) a first layer comprising one or more polysaccharides or polysaccharide biopolymers as further described herein and comprising an effective amount of at least one antimicrobial agent; and ii) a second layer comprising a polyethylene or a chitosan. At least a first portion of the first layer is disposed on at least a portion of the second layer. In certain embodiments, all of the first layer is disposed on all of the second layer. In embodiments, a material of this disclosure overlaps another component of food packaging, non-limiting examples of which include foam, plastics, polystyrene, and the like.

By incorporating an antimicrobial agent, using lauric arginate as an illustrative example, into a composite or laminated polymer film the antimicrobial agent can be slowly released onto the food surface over time. This is advantageous and more desirable than applying the compound directly to a food surface, which will run off and not be as effective against microorganisms. In this regard, antimicrobial release rates from the described materials can be determined using any suitable approach, examples of which are known in the art. (See, for example, Takhistov, Paul. (2007). Antimicrobial Packaging: Inactivation Kinetics and Release Modes. Journal of Applied Packaging Research 1(3), 163-179, the disclosure of which is incorporated herein by reference). In embodiments, the antimicrobial release rate can be determined from the bacterial growth inhibition results described herein.

In embodiments, the disclosure includes an effective amount of an antibacterial agent. The term “effective amount” is an amount that will bring about a biologically meaningful decrease in the amount of or extent bacteria, or inhibition or prevention of bacterial growth, or bacterial killing. In embodiments, an “effective amount” contains an amount that is effective to prevent or inhibit growth of bacteria relative to a reference value obtained from use of control composition that does not contain the antibacterial composition, or contains less of the antibacterial composition relative to the effective amount.

The concentration/amount of antimicrobial compound(s) will depend upon a number of factors. Non-limiting examples of factors include food type (e.g., cooked or raw), pathogen of concern, level of fat, level of protein, level of moisture, and the like and combinations thereof. In various embodiments, the concentration/amount of antimicrobial compound(s) depends on one or more or all of these factors. In embodiments, an antimicrobial agent is provided at 0.5 to 2.5% v/v of a described material.

In embodiments, an antimicrobial agent of this disclosure comprises lauric arginate (LAE). The disclosure demonstrates that LAE is superior for use in the described materials to thymol and nisin.

In embodiments, the material may comprise only one antimicrobial agent and be effective in controlling bacterial growth while providing suitable physical and/or mechanical properties. In embodiments, only LAE is used and is effective in controlling bacterial growth. In embodiments, a composition, material or product of this disclosure may further comprise any suitable antioxidant. In embodiments, a composition, material or product of this disclosure may further comprise any suitable nanoparticles. Suitable nanoparticles include but are not necessarily limited to metal nanoparticles, which may comprise silver, copper, gold, titanium dioxide (TiO2), zinc oxide (ZnO), magnesium oxide (MgO), and bimetallic silver-copper. In embodiments, a component of the described material may be incorporated into chitosan.

In embodiments, in addition to the antimicrobial agents described in the Examples, the antimicrobial agent may be selected from, other food grade compounds such as sodium benzoate, benzoic acid, sorbates, calcium acetate, potassium sorbate, propionic acid, sorbic anhydride, gallic acid, eugenol, propyl paraben, lysozyme, lactoferrin, glucose oxidase, benomyl, imazalil, silver zeolite, allyl isothiocyanate (AIT), bacteriophages, chelators, such as EDTA, sulfur nanoparticles, one or more phytochemicals, quaternary ammonium salts, propionic acid, sodium propionate, calcium propionate and potassium propionate starch, essential oils, other bacteriocins, including those described in the Examples, and Plantaricin BM 1, Lacticin 3147A, Pediocin PA-1, Enterocin AS-48, Bacteriocin 7293, and Sakacin-A.

In embodiments, a material of this disclosure is, or is a component of, an active packaging. In general, active packaging comprises food packaging that includes at least one of the following: improves shelf life, monitors freshness, measure gas or moisture levels, detect pathogens. The material may comprise other components, such as O₂ scavengers, CO₂ scavengers, C₂H₄ emitters, and moisture scavenging systems. In embodiments, the described material may comprise any oflignin, curcumin, pinosylvin, resveratrol, murta fruit extract, green tea extract, turmeric extract, grape fruit seed extract, clove extract, and horseradish extract.

In embodiments, a component of a material described herein may be encapsulated. In embodiments, an antimicrobial agent is encapsulated in nanoparticles, cyclodextrins, liposomes, or emulsions. In embodiments, a described material comprises core-shell nanofibers, e.g., electrospun core-shell nanofibers loaded with antimicrobial compounds, examples of which are known in the art and can be made, for example, by coaxial electrospinning and emulsion electrospinning. Non-limiting examples of encapsulation materials include gelatin, polyvinyl alcohol, poly(ethylene oxide), Zein, and polylactic acid. In embodiments, a component of the described material may be provided as halloysite nanotubes.

In embodiments, the described materials comprise one or a combination of glycerol, locust bean, gelatin, and/or xanthan gum.

The disclosure is expected to be effective in controlling any bacteria that may be present in food products, including Gram-positive and Gram-negative bacteria. In non-limiting embodiments, the material is effective in inhibiting or preventing growth of bacteria that may be pathogenic to humans, and/or contribute to food spoilage. In non-limiting embodiments, a material of this disclosure can inhibit growth of Shiga toxin-producing E. coli (STEC), Salmonella spp., Listeria monocytogenes (L. monocytogenes) and Staphylococcus aureus (S. aureus). In embodiments, the disclosure provides for controlling the growth of fungi (yeast or molds). In embodiments, the disclosure provides for controlling growth of any of Saccharomyces cerevisiae, Escherichia coli, Lactobacillus plantarum, Brochothrix thermosphacta, Staphylococcus aureus, E. coli, Lb. plantarum, Fusarium oxysporum, Enterococcus faecalis, Enterobacter spp., lactic acid bacteria, Aspergillus niger, Bacillus coagulans, Bacillus cereus, Salmonella Typhimurium, and Klebsiella pneumoniae.

As described above, in embodiments, the antimicrobial agent has a release rate that can be determined from the bacterial growth inhibition results described herein. In embodiments, the release rate reduces the growth rate of any of the described bacteria over a period of days. In embodiments, growth of the bacteria is inhibited, which may include growth prevention, for a period of refrigerated (e.g., at approximately 4° C.) storage for period of at least 7-28 days, inclusive, and including all time periods and intervals of time periods there between. Longer periods are included, such as 28-60 days, or more. In embodiments, the antimicrobial penetrates the food with which a described material, such as by migrating to 1, 2, 3, 4, or 5 mm into the food product.

In embodiments, the described inhibition of growth is for any one or a combination of the bacteria described herein. In embodiments, the inhibition of growth comprises killing bacteria. In embodiments, inhibition of growth comprises inhibition formation of colony forming units, wherein the inhibition may be compared to any suitable control or reference value. In embodiments, growth of bacteria on a food substance, including but not necessarily limited to ready-to-eat or raw muscle foods. In embodiments, the disclosure provides for controlling the growth of fungi (yeast and/or molds).

In embodiments, a material of this disclosure is provided in any form, including but not limited to sheets, rolls, and the like. In embodiments, a material of this disclosure is provided as a sachet, or a bag. In embodiments, a material of this disclosure is sealed in contact with at least a portion of a food product. In embodiments, a product of this disclosure is sealed under vacuum. In embodiments, a material of this disclosure is exposed to radiation, including but not necessarily limited to ultraviolet radiation. In embodiments, comprised by two layers of the described materials may be bonded together by any known technique such as co-extrusion, laminating with or without an adhesive, coating, or other methods. In embodiments, the materials comprise two of the described layers. In embodiments, more than two layers of one or both of the described layers may be included.

In embodiments, a material of this disclosure is provided as a component of a food package. In embodiments, the food package contains any food product that is susceptible to contamination with bacteria, including but not necessarily limited to bacteria that are pathogenic to humans, or to non-human mammals. In embodiments, the food product comprises a muscle food. In embodiments, the food product comprises a mammalian, non-human meat product, or a fowl, fish, seafood, or shellfish food product. In an embodiment, the food comprises a ready-to-eat (RTE) food product, including but not limited to, for example, deli meat. In embodiments, the food product comprises beef, chicken, or turkey. In embodiments, the food product comprises a ground meat. In embodiments, the food product comprises a vegetable or a fruit or a nut product. In embodiments, the food product comprises a liquid or semi-liquid product, such products including but not necessarily limited to beverages, including juices and milk-based beverages, and coffee drinks. In embodiments, the food product comprises a cream, butter, yogurt, or a frozen product, such as ice cream products. Products made in this manner are included in the scope of the disclosure. In embodiments, the disclosure includes providing a material as described herein, and packaging a food product with said material.

As discussed above, in embodiments, a non-limiting aspect of this disclosure includes use of Pullulan (Pu). Pu is a water-soluble, biodegradable, biocompatible, non-toxic, non-carcinogenic, non-mutagenic and edible polysaccharide, produced by the yeast, Aureobasidium pullulans (Singh et al., 2019; Silva et al., 2018). The antimicrobial properties of Pu films and coatings incorporated with nisin Z, sakacin A, lauric arginate (LAE), essential oils and/or nanoparticles have been found to effectively control foodborne pathogens on various fresh and further-processed meat, poultry, and seafood products (Morsy et al., 2014; Pattanayaiying et al., 2015a, 2015b; Trinetta et al., 2010). However, Pu films, like most bio-based films, are hydrophilic, water soluble, less durable and non-sealable. These disclosures also demonstrated that edible films cannot be used alone for vacuum packaging of foods; but rather, must be paired with vacuum packaging using polyethylene (PE) blends and/or chitosan to achieve durability, resistance, sealability, and stability, while also being impermeable to water vapor and oxygen (Pattanayaiying et al., 2015b; Trinetta et al., 2010, 2011). Unfortunately, PE as previously used is not biocompatible, has been difficult to incorporate with antimicrobial substances, and receives low consumer acceptability due to issues with disposal. Therefore, the development of innovative food packaging films made of a combination of a bio-based material with antimicrobial properties and a plastic polymer is an aspect of this disclosure.

Given the nonpolar nature of PE that induces poor adhesive bonding with polar surfaces and interfaces, several physical, chemical, thermal and electrical approaches, including corona and plasma treatment, have been developed to modify the surface properties of PE to increase its hydrophilicity (Debnath et al., 2005; Guruvenket et al., 2004; Ng et al, 2000). However, these approaches are expensive, require high-tech equipment, and can have a negative environmental impact (Farris et al., 2009). Previous studies focused only on the effect of using biopolymeric layers to improve the oxygen barrier property of plastic films. Moreover, they used expensive technologies for surface treatment of plastic before coating (Hozumi et al., 2004; O'Connell et al., 2009; Temmerman et al., 2005).

In non-limiting embodiments, the present disclosure relates to the development of a novel composite CAF or LAF made from Pu containing lauric arginate (LAE) as at least one antimicrobial agent, that can bonded/adhered to PE as described herein, made into any suitable material for fully or partially containing a food product, and used for antimicrobial activity against foodborne pathogens associated with fresh or further processed meat and poultry products, and other food products as described herein. Certain of the described materials are edible, biodegradable, and/or recyclable.

In embodiments, the described materials may also or alternatively comprise any of poly(vinyl chloride) (PVC), polypropylene (PP), poly(ethylene-co-vinylacetate) (EVA), poly(ethylene terephthalate) (PET), Polylactic acid (PLA), cellulose, methylcellulose (MC), hydroxypropyl methylcellulose (HPMC), nylon, and linear low-density polyethylene (LLDPE). In embodiments, the described materials may include any biodegradable polymer that is described in, for example, Siragusa, et al. Biodegradable polymers for food packaging: a review, Trends in Food Science & Technology 19 (2008) 634e643, the disclosure of which is incorporated herein by reference.

The materials that comprise antimicrobial agents as described herein may also or alternatively comprise copolymers, a non-limiting example of which is ethylene vinyl alcohol (EVOH), a formal copolymer of ethylene and vinyl alcohol. EVOH is commercially available in several grades with different ratios of ethylene/vinyl alcohol in the polymer chain. In some embodiments, EVOH can include saponified or hydrolyzed ethylene/vinyl acetate copolymers. In non-limiting embodiments, the EVOH can have an ethylene content ranging from about 80 to about 99 mole percent. In embodiments, the EVOH can have an ethylene content ranging from about 90-95%. In an embodiment, the EVOH comprises 95% ethylene. In embodiments, the material or a portion thereof comprises a maximum of 5% EVOH, such as v/v. EVOH has well known properties which are described in for example, Maes, et al. (2018) Recent Updates on the Barrier Properties of Ethylene Vinyl Alcohol Copolymer (EVOH): A Review, Polymer Reviews, 58:2, 209-246, the disclosure of which is incorporated herein by reference). In embodiments, a material of this disclosure comprises PE and EVOH. In embodiments, the material comprises 95% PE and 5% EVOH by weight.

The following Examples are intended to illustrate but not limit the disclosure. The Part I Examples demonstrate at least in part that CAFs containing LAE at 1.0 or 2.5% significantly reduced foodborne pathogens (STEC, Salmonella spp., L. monocytogenes and S. aureus) experimentally inoculated onto the surfaces of raw and RTE muscle foods over 28 days of refrigerated storage. CAFs made with 2.5% LAE maintained proper physical, mechanical and optical characteristics which allowed for use in these experiments. The Part II Examples contain additional information on the optical and mechanical characteristics of the described materials, including LAFs. The disclosure is expected to also be suitable for food storage in frozen conditions.

### Part I—Example 1

### MIC and MBC of Antimicrobials

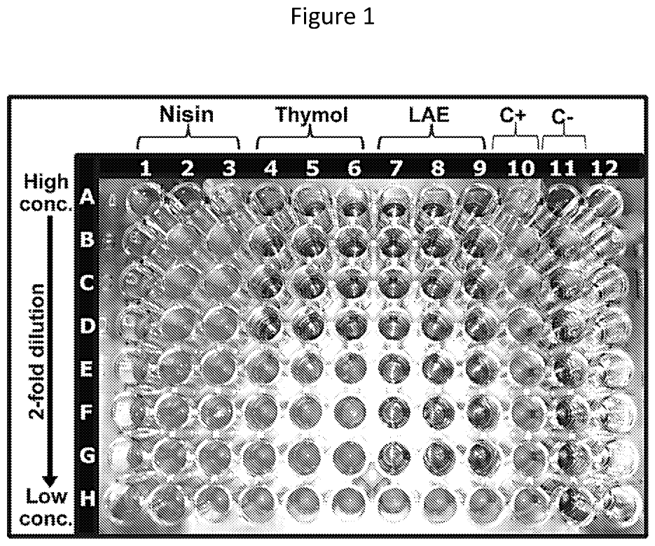

The results of the MIC experiments using the resazurin indicator-based 96-well microplate dilution method and MBC experiments are presented in FIG. 1 and Table 2. Nisin, even at high levels (50,000 IU/mL), demonstrated very poor antibacterial activity against the Gram-positive (L. monocytogenes and S. aureus) and Gram-negative (STEC and Salmonella spp.) pathogens evaluated in this disclosure. These results are consistent with nisin exhibiting a narrow spectrum of antimicrobial activity towards Gram-positive bacteria and therefore, cannot be used to control or reduce Gram-negative pathogens (Pattanayaiying et al., 2014; Pattanayaiying et al., 2015a).

Conversely, the broad-spectrum antibacterial activity of LAE was notable; 0.078% of LAE inhibited all tested bacterial pathogens. LAE also demonstrated greater inhibition against Gram-positive bacteria than Gram-negative, since the MBC of Gram-negative pathogens (STEC and Salmonella spp.) was 0.625%, whereas the MBC was 0.313% for Gram-positive pathogens (L. monocytogenes and S. aureus). LAE is a known, natural cationic surfactant with a broad-spectrum antimicrobial activity (Luchansky et al., 2005; Rodriguez et al., 2004) so these findings are not unusual.

The MICs for thymol ranged from 0.156 to 1.25% and the MBCs ranged from 1.25 to 2.5%, with higher efficiency against Gram-positive than Gram-negative pathogens. Thymol is a phenolic monoterpene compound and represents one of the major constituents of the essential oil fraction of the thyme plant (Thymus vulgaris L., Lamiaceae) (Salehi et al., 2018). Thymol has been added to foods as a flavor enhancer (Beuchat, 1994) and has long been used as a food preservative due to its antibacterial, antifungal and antioxidant activities (Evans and Martin, 2000; Hoferl et al., 2009; Sharifi-Rad et al., 2017; Ultee et al., 2000).

### Part I—Example 2

### Qualitative Determination of the Antimicrobial Activity of CAFs

The zones of inhibition for the different films are provided in Table 3. CAFs with combinations of nisin (0 and 10,000 IU/mL), thymol (0, 1 and 2%) and LAE (0, 0.5, 1.0, and 2.5%) were used in this example. Control PE films and Pu/PE films without antimicrobials that were used as negative controls demonstrated no inhibition. The antimicrobial activity of the various CAFs using DDAs mirrored the results obtained in the MIC and MBC studies. CAFs with nisin alone did not exhibit any inhibition towards Gram-negative and Gram-positive bacterial pathogens. Similar results were obtained by Pattanayaiying et al. (2015a) in terms of Gram-negative bacteria when no inhibition was recorded by pullulan films containing nisin alone. Conversely, researchers reported inhibition against Gram-positive bacteria, including L. monocytogenes, S. aureus, and Brochothrix thermosphacta when evaluated using nisin-containing films. Additionally, Pattanayaiying et al. (2015a) declared that the efficiency of the film incorporated with both LAE and nisin Z was higher than the film containing either LAE or nisin alone. The researchers indicated that nisin Z might increase the bacterial cell membrane permeability by making pores in it, allowing the access of LAE inside the cells (Pattanayaiying et al., 2014). In the current disclosure, the addition of nisin to films did not induce any significant differences (P≤0.05) in the effectiveness of CAFs containing thymol and/or LAE. Without intending to be bound by any particular theory, it is assumed that these differences could be attributed to the dissimilarity in the type and source of nisin used in this study. Pattanayaiying et al. (2015a) used partially purified nisin Z produced in vitro using Lactococcus lactis subsp. lactis, the bacteriocin-producing lactic acid bacteria (Pattanayaiying et al., 2015a), while commercially purchased nisin was used in this disclosure. On the other hand, there was a direct relationship between the effectiveness of CAFs and the concentration of thymol and LAE. The antimicrobial activity of thymol is attributed to its effect on the structural and functional properties of bacterial cell membrane, which can induce lethal or sublethal injury (Lambert et al., 2001). The broad-spectrum antimicrobial activity of LAE-containing CAFs against both Gram-positive and Gram-negative bacteria was very noticeable, where the efficiency against Gram-positive bacteria was significantly higher than Gram-negative bacteria (P≤0.05). LAE disrupts the membrane lipid bilayer, interferes in metabolic processes, and hinders the cellular cycle of bacterial cells (Bakal and Diaz, 2005; The Target Group, Inc., 2012).

Since thymol is soluble only in ethanol and nisin is soluble in HC1, the two solvents interfered with the binding of Pu to PE, thymol and nisin were not used further in the challenge studies. Thus, in embodiments, a material of this disclosure made be fee of ethanol and/or HCL, which also applies to the described methods of making the materials. In contrast, LAE can be dissociated in water to an active form (Manso et al., 2011) and is demonstrated to be a broad-spectrum antimicrobial in the materials of this disclosure. Interestingly, CAFs with up to 2.5% LAE alone maintained good physical, mechanical and optical properties in terms of tensile strength, elastic modulus, puncture resistance, transparency and seal-ability (data not shown). Meanwhile, there was no significant difference (p<0.05) between CAFs made with LAE 2.5% (CAF T 0, N 0, LAE 2.5%) and CAFs made with the highest concentrations of the three antimicrobial agents together: thymol 2%, nisin 10000 IU/mL and LAE 1% (CAF T 2, N 10000, LAE 1) (Table 3). Given these results, LAE is considered to be a suitable antimicrobial agent that can be used with the materials of this disclosure. Further, its efficiency is higher than essential oil-derived compounds (Becerril et al., 2013). Additionally, toxicological studies have demonstrated that LAE can be rapidly metabolized in the human body to lauric acid and arginine (Hawkins et al., 2009), hence it was deemed to be a generally recognized as safe compound (GRAS) by the U.S. Food and Drug Administration (FDA) in 2005 and was approved as a safe food preservative by the European Food Safety Authority (EFSA) in 2007 (Kawamura and Whitehouse, 2008). Given the aforementioned properties of LAE as a safe broad-spectrum antimicrobial food additive, the physical and mechanical properties of LAE-containing CAFs, and the limitations of thymol and nisin-containing CAFs, CAFs containing LAE alone were evaluated for their effectiveness against foodborne pathogens inoculated onto the surface of muscle foods in subsequent challenge studies.

### Part I—Example 3

Effect of CAFs Against Foodborne Pathogens Associated with Fresh and RTE Muscle Foods.

Based on the antimicrobial activity results of CAFs through DDAs and the physical and mechanical properties of different synthesized films (data not shown), CAFs containing 0.5, 1.0 or 2.5% LAE, as well as control films (PE and Pu/PE) were made and used to evaluate the antimicrobial activity against pathogens associated with muscle foods during refrigerated storage at 4° C. up to 28 days.

### Part I—Example 4

### Inhibition of STEC on Fresh Beef

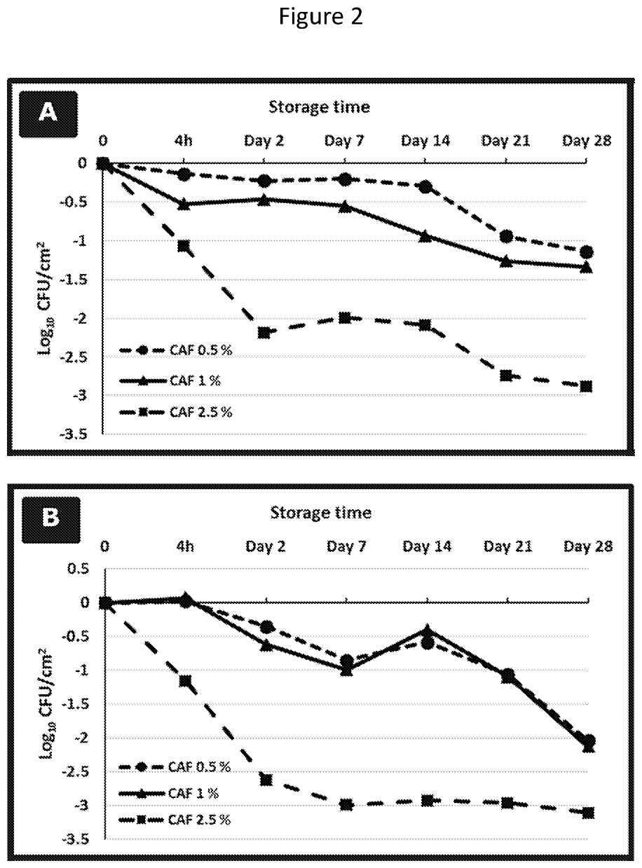

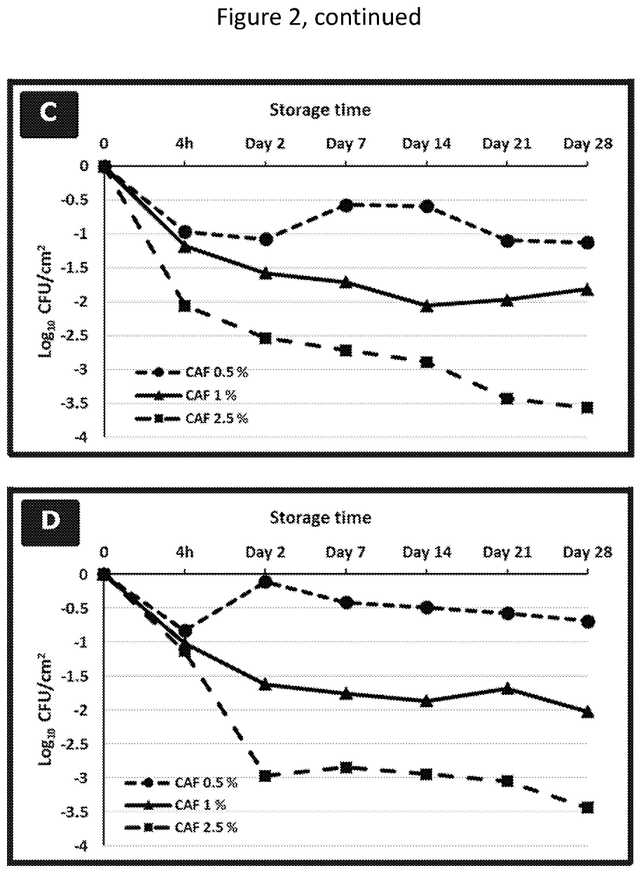

After experimental inoculation onto beef, STEC remaining populations of approximately 6.6 log₁₀ CFU/cm² were obtained (Table 4 and FIG. 2A). For samples packaged using control films without antimicrobials (PE and Pu/PE), the populations fluctuated throughout the storage period, but ended with a slight increase at day 28 (6.70 and 6.68 log₁₀ CFU/cm², respectively). These results are not unusual given that vacuum packaging and low storage temperatures do not allow pathogens to grow to very high levels (Pattanayaiying et al., 2015a). Beef slices treated with CAF containing 2.5% LAE reduced the STEC approximately 2.4 log₁₀ CFU/cm² after 2 days of storage (significantly lower than others at p<0.05) and an additional reduction of 0.44 log₁₀ CFU/cm² until day 28 of storage. The remaining populations after 28 days of refrigerated storage were 5.57, 5.37 and 3.83 log₁₀ CFU/cm² in samples packaged with CAF/LAE 0.5%, CAF/LAE 1% and CAF/LAE 2.5% films, respectively, which are significantly lower than control films (p<0.05). By 28 days of storage, log reductions of 1.13, 1.33 and 2.88 log₁₀ CFU/cm² were observed with treatments of CAF containing 0.5% LAE, 1% LAE, and 2.5% LAE 2.5%, respectively (FIG. 2A). These findings agree with other researchers who have also observed reductions of pathogenic E. coli by LAE, alone or in combination with biopolymers (Becerril et al., 2013; Pattanayaiying et al., 2014; Bakal and Diaz, 2005; Pattanayaiying et al., 2015a; The Target Group, Inc., 2012).

### Part I—Example 5

### Inhibition of Salmonella on Fresh Chicken Breast

The remaining population of Salmonella spp. on fresh chicken breast was determined after experimentally inoculating with approximately 6.6 log₁₀ CFU/cm² (Table 5 and FIG. 2B). Samples packaged in control PE and PE/Pu films demonstrated a slight reduction after 4 h of inoculation, which could be attributed to the effect of vacuum packaging and cold storage; increases in bacterial populations were recorded at days 2 and day 7. Bacterial populations fluctuated slightly thereafter. Conversely, Pattanayaiying et al. (2015a) reported that the count of Salmonella on turkey breast, wrapped with control pullulan film increased by 1 log₁₀ CFU/cm² after 7 days of cold storage before gradually decreasing afterwards.

CAFs containing LAE 0.5% or LAE 1% resulted in slight reductions initially, with overall reduction rates of 2.03, 2.12 log₁₀ CFU/cm², respectively, after long-term refrigerated storage. Eventually, the total reduction in Salmonella by CAF/LAE 2.5% was 3.01 log₁₀ CFU/cm² at day 28 (FIG. 2B). The final counts at day 28 were significantly higher in control films than LAE-containing CAFs (P<0.05).

### Part I—Example 6

Inhibition of L. monocytogenes on RTE Turkey Breast

The remaining populations of L. monocytogenes on experimentally-inoculated turkey breast are presented in Table 6 and FIG. 2C. For samples packaged in LAE-containing films, the populations were significantly lower than controls at all time points (p<0.05). After 4 h of storage, the counts in samples packaged in CAFs containing LAE 2.5% were reduced by about 2.05 log₁₀ CFU/cm², then gradually declined to 3.56 log₁₀ CFU/cm² by day 28. These findings agree with Theinsathid et al. (2012) who reported a 3 log₁₀ CFU/test piece reduction in L. monocytogenes on cooked sliced ham after wrapping with 2.6% LAE-coated polylactic film. Interestingly, Pattanayaiying et al. (2015a) also demonstrated that L. monocytogenes Scott A inoculated onto the surface of ham slices wrapped with pullulan film containing LAE (2%) were reduced immediately after exposure, but with increases in populations over time. In this study, a cocktail of three strains of L. monocytogenes was used while the other studies only used one strain of L. monocytogenes, possibly explaining the observed differences. Moreover, Pattanayaiying et al. (2015a) also confirmed that the pullulan film containing nisin Z alone was useless against L. monocytogenes, since the counts increased significantly during long-term, refrigerated storage. This finding also confirms our earlier results regarding the lack of antibacterial activity of nisin towards the pathogen.

In this study, observed reductions of 1.12 and 1.81 log₁₀ CFU/cm² for L. monocytogenes following treatments with CAF/LAE 0.5% and CAF/LAE 1% films also are in agreement with those of Becerril et al. (2013), who claimed that LAE demonstrated strong antimicrobial activity against Listeria innocua, and Pattanayaiying et al. (2014), who demonstrated alterations in cell morphology when L. monocytogenes was treated with LAE.

### Part I—Example 7

Inhibition of S. aureus on RTE Turkey Breast

After experimental inoculation onto turkey breast, populations of approximately 6.6 log₁₀ CFU/cm² S. aureus were obtained (Table 7 and FIG. 2D). For samples packaged in LAE-containing films, the counts were significantly lower than control ones at all time points (p<0.05). Furthermore, samples treated with CAF/LAE 1% and CAF/LAE 2.5% were significantly lower than other films on days 2 and 28 of refrigerated storage (p<0.05). Reductions of 0.68, 2.02 and 3.43 log₁₀ CFU/cm² were observed when treated with CAF/LAE 0.5%, CAF/LAE 1% and CAF/LAE 2.5% films, respectively. In this disclosure, samples packaged in control films were reduced by 0.5 log₁₀ CFU/cm² on day 28 (FIG. 2D).

TABLE 1
Bacterial strains.

| Pathogen | Strain | Source | Isolation |
|---|---|---|---|
| STEC cocktail | E. coli O157:H7 | ATCC | Raw hamburger |
| | | 43895 | implicated in |
| | | | hemorrhagic |
| | | | colitis outbreak |
| | E. coli O145 | ATCC | Human stool |
| | | BAA-2192 | |
| | E. coli O111 | ATCC | Human stool |
| | | 43887 | |
| Salmonella spp. | S. Typhimurium | CDC ST4 | Human stool, |
| cocktail | | | Colorado, USA |
| | S. Entertidis | CDC | Human stool, |
| | | SE29 | Idaho, USA |
| | S. Saintpaul | CDC SS10 | Human, |
| | | | Massachusetts, USA |
| Listeria | LM FSL J1-003 | PSU | |
| monocytogenes | LM FSL J2-685 | PSU | |
| cocktail | LM FSL J1-129 | PSU | |
| Staphylococcus | S. aureus subsp. | ATCC | Ham involved in |
| aureus cocktail | aureus Rosenbach | 13565 | foodborne outbreak |
| | S. aureus subsp. | ATCC | Sliced turkey |
| | aureus Rosenbach | 27154 | |
| | S. aureus subsp. | ATCC | Chicken tetrazzini |
| | aureus Rosenbach | 27664 | |

STEC, Shiga toxin-producing E. coli
ATCC, American Type Culture Collection
CDC, Centers for Disease Control and Prevention
PSU, Penn State University Food Microbiology Culture Collection

TABLE 2
Minimum inhibitory concentration (MIC) by resazurin indicator-based, 96-well
microplate dilution method and minimum bactericidal concentration (MBC)
of each antimicrobial agent against various foodborne pathogens.

| | Nisin IU/mL (W/V) | | Thymol % (W/V) | | LAE % (V/V) | |
|---|---|---|---|---|---|---|
| Bacterial cocktails | MIC | MBC | MIC | MBC | MIC | MBC |
| STEC | Nil | Nil | 1.25 | 2.5 | 0.078 | 0.625 |
| Salmonella spp. | Nil | Nil | 0.625 | 2.5 | 0.078 | 0.625 |
| L. monocytogenes | Nil | Nil | 0.625 | 1.25 | 0.078 | 0.313 |
| S. aureus | Nil | Nil | 0.156 | 1.25 | 0.078 | 0.313 |

STEC, Shiga toxin-producing E. coli
Nil indicates there was no growth inhibition, nor killing effect at ≤ 50,000 IU/mL

TABLE 3
The antimicrobial activity of composite antimicrobial films (CAFs) incorporated
with various antimicrobials (T, thymol. N, nisin. LAE, lauric arginate),
represented by the diameter of inhibition zones (mm), against different
foodborne pathogens in a disc diffusion assay (DDA).

| | Inhibition zone diameter (mm) | | | |
|---|---|---|---|---|
| CAFs with thymol (%), | | Salmonella | L. mono- | |
| nisin (×1000 IU/mL) | STEC | spp. | cytogenes | S. aureus |
| and LAE (%) | cocktail | cocktail | cocktail | cocktail |
| PE (Control) | 0.0 ± 0.0^{d} | 0.0 ± 0.0^{g} | 0.0 ± 0.0^{g} | 0.0 ± 0.0^{g} |
| Pu/PE (Control) | 0.0 ± 0.0^{d} | 0.0 ± 0.0^{g} | 0.0 ± 0.0^{g} | 0.0 ± 0.0^{g} |
| CAF (T 0/N 0/LAE 0.5) | 6.0 ± 0.0^{c} | 6.3 ± 0.57^{ef} | 8.0 ± 0.0^{def} | 10.3 ± 0.57^{def} |
| CAF (T 0/N 0/LAE 1) | 8.3 ± 0.57ª^{b} | 8.3 ± 0.57^{bcd} | 13.0 ± 1.0^{ab} | 13.6 ± 0.57^{ab} |
| CAF (T 0/N 10/LAE 0) | 0.0 ± 0.0^{d} | 0.0 ± 0.0^{g} | 0.0 ± 0.0^{g} | 0.0 ± 0.0^{g} |
| CAF (T 0/N 10/LAE 0.5) | 6.3 ± 0.57^{c} | 6.0 ± 0.0^{f} | 7.6 ± 0.57^{ef} | 10.6 ± 0.57^{def} |
| CAF (T 0/N 10/LAE 1) | 8.3 ± 0.57^{ab} | 8.3 ± 0.57^{bcd} | 14.3 ± 0.57^{b} | 13.6 ± 0.57ª^{b} |
| CAF (T 1/N 0/LAE 0) | 6.0 ± 0.0^{c} | 6.0 ± 0.0^{f} | 7.0 ± 0.0^{f} | 9.6 ± 0.57^{f} |
| CAF (T 1/N 0/LAE 0.5) | 6.6 ± 0.57^{c} | 7.3 ± 0.57^{def} | 9.0 ± 0.0^{cde} | 11.6 ± 0.57^{cd} |
| CAF (T 1/N 0/LAE 1) | 8.6 ± 0.57^{ab} | 9.0 ± 0.0^{ab} | 15.0 ± 0.0ª | 14.6 ± 0.57ª |
| CAF (T 1/N 10/LAE 0) | 6.3 ± 0.0^{c} | 6.0 ± 0.0^{f} | 7.3 ± 0.57^{f} | 10.0 ± 0.0^{ef} |
| CAF (T 1/N 10/LAE 0.5) | 6.6 ± 0.57^{c} | 7.0 ± 0.0^{def} | 9.3 ± 0.57^{cd} | 11.3 ± 0.57^{cde} |
| CAF (T 1/N 10/LAE 1) | 8.6 ± 0.57^{ab} | 8.6 ± 0.57^{abc} | 14.6 ± 0.57ª | 14.6 ± 0.57ª |
| CAF (T 2/N 0/LAE 0) | 6.3 ± 0.57^{c} | 6.3 ± 0.57^{ef} | 8.0 ± 0.0^{def} | 10.3 ± 0.57^{def} |
| CAF (T 2/N 0/LAE 0.5) | 7.3 ± 0.57^{bc} | 7.6 ± 0.57^{cde} | 9.3 ± 0.57^{cd} | 12.3 ± 0.57^{bc} |
| CAF (T 2/N 0/LAE 1) | 9.3 ± 0.57ª | 9.3 ± 0.57ª | 15.3 ± 0.57ª | 15.0 ± 0.0ª |
| CAF (T 2/N 10/LAE 0) | 6.0 ± 0.0^{c} | 6.3 ± 0.57^{ef} | 8.3 ± 0.57^{def} | 10.3 ± 0.57^{def} |
| CAF (T 2/N 10/LAE 0.5) | 7.3 ± 0.57^{bc} | 7.3 ± 0.57^{def} | 9.6 ± 0.57^{c} | 12.3 ± 0.57^{bc} |
| CAF (T 2/N 10/LAE 1) | 9.0 ± 0.0ª | 9.3 ± 0.57ª | 15.6 ± 0.57ª | 15.0 ± 0.0ª |
| CAF (T 0/N 0/LAE 2.5) | 8.6 ± 0.57^{ab} | 9.0 ± 1.0^{ab} | 15.3 ± 0.57ª | 14.6 ± 0.57ª |

Data represent the mean of 3 replicates ± SD
Different a, b, c . . . letters in the same column indicate significant differences between means (p ≤ 0.05).
PE, polyethylene.
Pu, pullulan.
Pu/PE, Pullulan/Polyethylene films (the same formulation of CAF but without any antimicrobials) were used as control.

TABLE 4
Remaining bacterial populations (log₁₀ CFU/cm²) of a cocktail of STEC,
experimentally-inoculated onto raw beef slices, vacuum packaged in sachets/bags made of
polyethylene (PE), pullulan/polyethylene (Pu/PE) or composite antimicrobial films (CAF)
with different LAE concentrations (0.5, 1.0 or 2.5%) under refrigerated storage (4° C.).

| Packaging | Populations (log₁₀ CFU/cm²) during storage at 4° C. | | | | | |
|---|---|---|---|---|---|---|
| films | 4 hours | Day 2 | Day 7 | Day 14 | Day 21 | Day 28 |
| C (PE) | 6.38 ± 0.19ª | 6.27 ± 0.02^{b} | 6.24 ± 0.02ª | 6.06 ± 0.02^{b} | 6.64 ± 0.13ª | 6.70 ± 0.13ª |
| C (Pu/PE) | 6.17 ± 0.03^{ab} | 6.50 ± 0.04ª | 6.12 ± 0.12^{ab} | 6.25 ± 0.02ª | 6.58 ± 0.12ª | 6.68 ± 0.16ª |
| CAF/LAE 0.5% | 6.15 ± 0.02^{ab} | 6.16 ± 0.01^{c} | 5.98 ± 0.04^{b} | 5.87 ± 0.06^{c} | 5.68 ± 0.07^{b} | 5.57 ± 0.08^{b} |
| CAF/LAE 1.0% | 5.76 ± 0.05^{bc} | 5.92 ± 0.01^{d} | 5.63 ± 0.08^{c} | 5.21 ± 0.16^{d} | 5.36 ± 0.02^{b} | 5.37 ± 0.02^{b} |
| CAF/LAE 2.5% | 5.21 ± 0.11^{c} | 4.20 ± 0.01^{e} | 4.19 ± 0.07^{c} | 4.08 ± 0.03^{d} | 3.88 ± 0.06^{b} | 3.84 ± 0.04^{b} |

Data represent means of ≥ 3 replicates ± SD. C, control.
Different ª, ^{b}, ^{c} . . . letters in the same column indicate significant differences between remaining population means of packaging films on that day (p ≤ 0.05).

TABLE 5
Remaining bacterial populations (log₁₀ CFU/cm²) of a cocktail of Salmonella on
experimentally-inoculated raw chicken meat slices, vacuum packaged in sachets/bags made
of polyethylene (PE), pullulan/polyethylene (Pu/PE) or composite antimicrobial films (CAF)
with different LAE concentrations (0.5, 1.0 or 2.5%) under refrigerated storage (4° C.).

| Packaging | Populations (log₁₀ CFU/cm²) during storage at 4° C. | | | | | |
|---|---|---|---|---|---|---|
| films | 4 h | Day 2 | Day 7 | Day 14 | Day 21 | Day 28 |
| C (PE) | 6.17 ± 0.01^{ab} | 6.87 ± 0.05ª | 7.11 ± 0.17ª | 7.14 ± 0.02ª | 7.04 ± 0.14ª | 7.01 ± 0.11ª |
| C (Pu/PE) | 6.09 ± 0.03^{b} | 6.66 ± 0.03^{b} | 7.15 ± 0.01ª | 7.12 ± 0.14ª | 7.16 ± 0.04ª | 7.12 ± 0.04ª |
| CAF/LAE 0.5% | 6.15 ± 0.08ª^{b} | 6.41 ± 0.04^{c} | 6.30 ± 0.03^{b} | 6.55 ± 0.07^{bc} | 6.03 ± 0.12^{b} | 5.04 ± 0.02^{b} |
| CAF/LAE 1.0% | 6.21 ± 0.02ª | 6.14 ± 0.01^{d} | 6.16 ± 0.02^{b} | 6.73 ± 0.09^{b} | 6.02 ± 0.05^{b} | 4.94 ± 0.03^{b} |
| CAF/LAE 2.5% | 4.97 ± 0.10^{c} | 4.14 ± 0.07^{e} | 4.15 ± 0.04^{b} | 4.21 ± 0.03^{c} | 4.14 ± 0.08^{b} | 3.97 ± 0.05^{b} |

Data represent means of ≥ 3 replicates ± SD. C, control.
Different ª, ^{b}, ^{c} ... letters in the same column indicate significant differences between remaining population means of packaging films on that day (p ≤ 0.05).

TABLE 6
Remaining bacterial populations (log₁₀ CFU/cm²) of a Listeria monocytogenes
cocktail, experimentally-inoculated onto turkey breast slices, vacuum packaged in
sachets/bags made of polyethylene (PE), pullulan/polyethylene (Pu/PE) or composite
antimicrobial films (CAF) with different LAE concentrations (0.5, 1.0 or 2.5%) under
refrigerated storage (4° C.).

| Packaging | Populations (log₁₀ CFU/cm²) during storage at 4° C. | | | | | |
|---|---|---|---|---|---|---|
| films | 4 hours | Day 2 | Day 7 | Day 14 | Day 21 | Day 28 |
| C (PE) | 6.21 ± 0.16ª | 5.43 ± 0.16^{b} | 5.57 ± 0.05ª | 5.54 ± 0.04ª | 5.65 ± 0.09^{b} | 5.77 ± 0.04^{b} |
| C (Pu/PE) | 5.92 ± 0.19^{ab} | 5.68 ± 0.14ª | 5.58 ± 0.08ª | 5.63 ± 0.12ª | 6.13 ± 0.02ª | 6.24 ± 0.04ª |
| CAF/LAE 0.5% | 5.12 ± 0.10^{b} | 4.50 ± 0.03^{c} | 5.02 ± 0.06^{b} | 4.98 ± 0.14^{b} | 4.73 ± 0.35^{c} | 4.89 ± 0.02^{c} |
| CAF/LAE 1.0% | 4.89 ± 0.15^{b} | 3.99 ± 0.11^{c} | 3.88 ± 0.05^{bc} | 3.53 ± 0.03^{b} | 3.92 ± 0.04^{c} | 4.19 ± 0.06^{c} |
| CAF/LAE 2.5% | 4.02 ± 0.12^{b} | 3.04 ± 0.07^{c} | 2.78 ± 0.33^{c} | 2.69 ± 0.10^{b} | 2.48 ± 0.03^{c} | 2.44 ± 0.08^{c} |

Data represent means of ≥ 3 replicates ± SD. C, control.
Different ª, ^{b}, ^{c} ... letters in the same column indicate significant differences between remaining population means of packaging films on that day (p ≤ 0.05).

TABLE 7
Remaining count (log₁₀ CFU/cm²) of a cocktail of Staphylococcus aureus,
experimentally-inoculated onto turkey breast slices, vacuum packaged in sachets/bags made
of polyethylene (PE), pullulan/polyethylene (Pu/PE) or composite antimicrobial films (CAF)
with different LAE concentrations (0.5, 1.0 or 2.5%) under refrigerated storage (4° C.).

| Packaging | Populations (log₁₀ CFU/cm²) during storage at 4° C. | | | | | |
|---|---|---|---|---|---|---|
| films | 4 hours | Day 2 | Day 7 | Day 14 | Day 21 | Day 28 |
| C (PE) | 5.91 ± 0.05ª | 5.52 ± 0.12ª | 5.83 ± 0.30ª | 5.68 ± 0.09ª | 6.07 ± 0.06ª | 6.18 ± 0.04ª |
| C (Pu/PE) | 5.94 ± 0.16ª | 5.68 ± 0.14ª | 5.71 ± 0.05^{ab} | 5.59 ± 0.04ª | 5.55 ± 0.09^{b} | 6.04 ± 0.03^{b} |
| CAF/LAE 0.5% | 5.10 ± 0.10^{b} | 5.50 ± 0.03ª | 5.37 ± 0.17^{bc} | 5.13 ± 0.21^{b} | 5.23 ± 0.13^{bc} | 5.39 ± 0.22^{c} |
| CAF/LAE 1.0% | 4.89 ± 0.15^{b} | 3.99 ± 0.11^{b} | 4.05 ± 0.02^{bc} | 3.76 ± 0.13^{b} | 4.13 ± 0.05^{c} | 4.08 ± 0.10^{d} |
| CAF/LAE 2.5% | 4.79 ± 0.07^{b} | 2.65 ± 0.05^{b} | 2.96 ± 0.04^{c} | 2.68 ± 0.13^{b} | 2.74 ± 0.15^{c} | 2.65 ± 0.20^{d} |

Data represent means of ≥ 3 replicates ± SD. C, control.
Different ª, ^{b}, ^{c} ... letters in the same column indicate significant differences between remaining population means of packaging films on that day (p ≤ 0.05).

The following materials and methods were used to obtain the results discussed in Part I of this disclosure.

### Reagents

Pullulan (Pu) was obtained from Hayashibara Co., LTD. (Okayama, Japan). Glycerol ≥99.7% was obtained from VWR Company (Radnor, Pa., USA). Lauric arginate (LAE) (CytoGuard™) was obtained from A&B Ingredients, Inc. (Fairfield, N.J., USA). Nisin (N) made from Lactococcus lactis, xanthan gum made from Xanthomonas campestris, and thymol (T)≥98.5% were obtained from Sigma Aldrich (St. Louis, Mo., USA).

### Bacterial Strains

Twelve different pathogenic bacterial strains were used for this study (Table 1), with three strains each of Shiga toxin-producing E. coli (STEC), Salmonella spp. (S), Listeria monocytogenes (LM) and Staphylococcus aureus (SA), and were obtained from the Penn State Food Microbiology Culture Collection (Department of Food Science, University Park, Pa., USA). Frozen (−80° C.) bacterial strains maintained in glycerol were transferred to tryptic soy broth (TSB; Difco; Detroit, Mich.) at 37° C. for 18 h, streak-plated onto tryptic soya agar (TSA) plates (Difco) at 37° C. for 18 h, before stock cultures were stored in tryptic soya semi-liquid agar (Difco; 37° C., 18 h) or on agar slants (37° C., 18 h followed by storage at 4° C.) for further use throughout the study. Muller Hinton broth (MHB; Difco) was used in a resazurin indicator-based, 96-well microplate dilution method for in vitro determination of minimum inhibitory concentration (MIC) and minimum bactericidal concentration (MBC) of antimicrobials against various bacterial pathogens (Elshikh et al., 2016). Muller Hinton agar plates (Difco) were used for in vitro determination of the antimicrobial activities of LAE, nisin and thymol through disc diffusion assays (DDAs) (Siragusa et al., 1999).

### In Vitro Determination of Minimum Inhibitory Concentration (MIC) and Minimum Bacterial Concentration (MBC) of Antimicrobials Against Different Foodborne Pathogens Preparation of Bacterial Inocula

A resazurin indicator-based, 96-well microplate dilution method (Elshikh et al., 2016) was used for in vitro determination of MIC and MBC of LAE, nisin and thymol against different foodborne pathogens. Overnight cultures were grown in TSB (37° C.) and a cocktail of STEC, Salmonella spp., L. monocytogenes and S. aureus was prepared by mixing equal volumes of the three corresponding strains to obtain approximately 8 log₁₀ CFU/mL of the pathogens. Bacterial cells were washed by centrifugation at 8000 rpm/10 minutes, and cell pellets were re-suspended in the same volume of sterile Mueller Hinton Broth (MHB; Difco).

### Preparation of Resazurin Indicator

Resazurin indicator solution (VWR) was prepared at a concentration of 0.015% in sterile distilled water, then the dye solution was filtered through 0.22 μm filter (VWR), before being refrigerated until use for up to one week after preparation.

### Determination of Minimum Inhibitory Concentration (MIC)

FIG. 1 illustrates the resazurin indicator-based, 96-well microplate dilution method for MIC determination of different antimicrobials against bacterial cocktails. A 100,000 IU/mL concentration of nisin (VWR) was dissolved in HCl 0.02N; 10% thymol (VWR) was prepared in concentrated ethanol; and 10% LAE (MB) was prepared in sterile distilled water. All antimicrobials were sterilized by filtration through a 0.22 μm filter (Pall; Ann Arbor, Mich.).). Each antimicrobial was diluted in sterile MHB to obtain a final concentration of 50,000 IU/mL of nisin, 5% thymol, and 5% LAE. Using a multi-channel pipette (Eppendorf; Haoppauge, N.Y.), one hundred μL of each antimicrobial in MHB was dispensed into a row in a 96-well microplate. Subsequent serial dilutions of the antimicrobials were made in MHB using the multi-channel pipette by transferring and mixing 50 μL of each compound to obtain antimicrobial concentrations of nisin (50,000-390.6 IU/mL), thymol (5-0.039%) and LAE (5-0.039%). Bacterial cocktails were diluted 1:100 in a sterile MHB to reach a concentration of approximately 6 log₁₀ CFU/mL, with 50 μL of each cocktail added to the respective well. Positive controls consisted of 100 μL of bacterial cocktails without antimicrobials; negative controls consisted of only a 100 μL of sterile MHB.

After the microtiter plates were incubated for 24 h at 37° C., 30 μL of resazurin (0.015%) was added to each well and incubated at 37° C. for an additional 3 h to observe for color change. Bacterial growth was detected by the reduction of resazurin (blue/purple) to resorufin (pink); whereas, no color change (blue/purple resazurin color remained unchanged) indicated no growth or inhibition by the antimicrobial. The lowest concentration of each antimicrobial that demonstrated no color change was recorded as the MIC, while higher concentrations with no color change were scored as above the MIC value. Positive controls demonstrated a color change from blue/purple to pink, while negative controls demonstrated no growth, indicating sterility of the procedures.

### Determination of Minimum Bactericidal Concentration (MBC)

The MBC was determined by directly inoculating the content of wells with concentrations higher than the MIC value on selective growth media. STEC, Salmonella spp., L. monocytogenes and S. aureus were spread-plated onto sorbitol MacConkey (SMAC) agar, XLD agar, Baird Parker (BP) agar and modified Oxford (MOX) agar (Biolog; Haywood, Calif., USA), respectively. SMAC and XLD plates were incubated at 37° C. for 24 h, while MOX and BP plates were incubated for 37° C. for 48 h. The MBC value was determined as the lowest concentration when there were no bacterial colonies observed (Elshikh et al., 2016).

### Development of a Composite Antimicrobial Film (CAF)

The disclosure includes but is not limited to all of the following compositions of matter, all combinations thereof, and all steps, under this “Development of a composite antimicrobial film (CAF)” section of the disclosure.

Sterile biopolymer films containing the antimicrobials were made by combining pullulan (Pu; 100-150 g/L), gelatin (10-50 g/L), xanthan gum (1-5 g/L) and glycerol (0.5-80 mL/L) in sterile distilled water (DW) and adding different concentrations of nisin, thymol and LAE, according to their MICs as follows. DW was heated to 90° C. on a hot plate stirrer, gelatin added with stirring, followed by Pu, and then xanthan gum to stabilize the mixture. Afterwards, the temperature of the mixture was increased to 150° C. with continuous stirring until all ingredients were dissolved. Finally, glycerol was added to plasticize the biopolymer. When all components were completely dissolved, the pH was adjusted to the isoelectric point of gelatin (8.5) using 1M NaOH. This step was done to reduce the electrostatic repulsion of gelatin molecules, thereby allowing gelatin to interact with other compounds (Djagny et al. 2001). The mixture was autoclaved at 121° C. for 15 min. Filter-sterilized, antimicrobial solutions were mixed with the biopolymer solution (cooled to 55° C.) to obtain the desired concentration. Pu-based biopolymer mixtures were prepared without antimicrobials and used as control films in subsequent experiments. The volumes and concentrations of the components used in making materials described herein are provided in Table A, from which the final amounts of the components in the described material can be determined.

TABLE A

| Reagent | Amount | Percent |
|---|---|---|
| DI water | 1000 mL | 78.8% |
| Gelatin | 30 g | 2.4% |
| Pullulan | 135 g | 10.6% |
| Xanthan Gum | 2.5 g | 0.2% |
| Glycerol | 70 mL | 5.5% |
| LAE | 31.5 mL | 2.5% |

Pieces of polyethylene (PE; Ultravac Solutions LLC, Kansas City, Mo.) were cut aseptically to 20 cm×30 cm and subjected to ultraviolet (UV) light treatment under a biological safety hood, where their distance from the lamp was approximately one meter, and the UV light at 254 nm according to Onyiriuka (1993) to increase the surface energy of PE, and to sterilize the surface of the PE film.

Approximately 25 mL of the liquid biopolymer (55° C.) was poured directly onto the UV-treated side of PE film and spread using a Microm II micrometer film applicator (Paul N Gardner Company, Inc., Pompano Beach, Fla. USA) with a sterile stainless-steel blade of 15 cm width under aseptic conditions. The biopolymer coating layer thickness was approximately 50 μm. The resulting composite antimicrobial films (CAFs) were allowed to dry at 25° C. and 40% relative humidity for 24 h under a biological safety hood. Control films were prepared without antimicrobials, using the same method as described above. All films were stored aseptically at 25° C. until used in experiments.

### Determination of the Antimicrobial Properties of Composite Antimicrobial Films (CAFs)

The antimicrobial properties of the CAFs were determined using disc diffusion assays (DDAs) (Siragusa et al., 1999). CAFs were prepared according to the above-mentioned method with different antimicrobial combinations; nisin 0 and 10000 IU/mL, thymol 0, 1 and 2% and LAE 0, 0.5, 1 and 2.5%. PE films and Pu/PE films without any antimicrobials were used as controls. All films were aseptically cut into rounded discs 5 mm in diameter and placed onto the surface of TSA plates that had been streak-plated with approximately 8 log₁₀ CFU/mL of each bacterial cocktail (Table 1) which were prepared from overnight cultures (grown at 37° C. for 18 h). All bacteria-inoculated TSA plates were incubated at 37° C. for 24 h and plates were observed for zones of inhibition. Zones of inhibition were measured using a ruler and diameters recorded.

### Challenge Study

Inoculation of Fresh and RTE Muscle Foods with Foodborne Pathogens

Raw beef (top round), raw chicken breast slices, and ready-to-eat turkey breast (deli meat) were purchased from a local supermarket, transported at 4° C. to the PSU Muscle Foods Microbiology Laboratory, and aseptically cut into thin slices of 25 cm² surface area (5 cm×5 cm). The slices were subjected to ultraviolet light treatment in a biological safety cabinet for 15 min/side to reduce the bacterial loads prior to inoculation (Cutter and Siragusa, 1994).

Bacterial cocktails in sterile PBS were made as described earlier. The STEC cocktail was inoculated onto raw beef slices; the Salmonella cocktail was inoculated onto raw chicken slices; and L. monocytogenes and S. aureus cocktails were separately inoculated onto turkey breast deli meat slices by aseptically spreading one mL of the 8 log₁₀ CFU/mL bacterial cocktail on each slice side (5 cm×5 cm) to achieve a final concentration of approximately 6.6 log₁₀ CFU/cm². The inoculated side was left undisturbed for 20 min to allow for bacterial attachment before inoculation and attachment of the other side.

### Packaging and Storage of Inoculated Muscle Foods

Based on the results of DDAs, LAE was found to be the most effective antimicrobial against all pathogens evaluated and was used subsequently in the challenge study. The inoculated food samples were aseptically placed into sachets/bags made of different films: PE alone (control), Pu/PE (control); CAF with 0.5% LAE; CAF with 1% LAE; and CAF with 2.5% LAE. Sachets/bags were vacuum sealed using an Ultravac 250 vacuum packaging machine (Koch Equipment; Kansas City, Mo.) under aseptic conditions and stored at 4° C. for up to 28 days until samples could be evaluated for pathogen populations.

### Pathogen Enumeration

Food samples were evaluated for pathogen populations at days 0 (4 hours), 2, 7, 14, 21, and 28 of refrigerated storage. Samples were analyzed in triplicate as follows. At each time point, meat samples were removed from the films aseptically, transferred to a sterile stomacher bag (Interscience; Rockland, Mass.), stomached (Seward 400 Stomacher; West Sussex, England) for 2 min with 25 mL buffered peptone water (BPW), the resulting stomachate serially diluted in BPW, and dilutions spread-plated onto selective media for enumeration of each pathogen cocktail in duplicate. STEC, Salmonella spp., L. monocytogenes and S. aureus were spread-plated onto SMAC agar, XLD agar, BP agar and MOX agar, respectively. SMAC and XLD plates were incubated at 37° C. for 24 h, while MOX and BP plates were incubated for 37° C. for 48 h. Then remaining pathogen colonies were counted manually and converted to log₁₀ CFU/cm². Isolated colonies of each pathogen were confirmed on selective agars via STEC, Salmonella spp., L. monocytogenes and S. aureus agglutination kits (Remel, Lenexa, Kans.; Oxoid).

### Statistical Analysis

The challenge study was carried out in triplicate. After the bacterial counts were converted to log₁₀ CFU/cm², means and standard deviations (SD) were calculated using Microsoft Excel (Trinetta et al., 2010). Log reduction was calculated by subtracting the remaining count means in CAF from remaining count means in control films. Significant differences and comparison among means were estimated using a one-way ANOVA test (Minitab 18 statistical software). Means were considered significantly different if P≤0.05.

References for the foregoing text—this reference listing is not an indication that any particular reference is material to patentability.

Bakal, G., Diaz, A., 2005. The lowdown on lauric arginate: food antimicrobial hammers away at plasma membrane, disrupting a pathogen's metabolic process. Food Qual. 12, 54-61.

Becerril, R., Manso, S., Nerin, C., Gomez-Lus, R., 2013. Antimicrobial activity of lauroyl arginate ethyl (LAE), against selected food-borne bacteria. Food Control 32, 404-408. doi.org/10.1016/j.foodcont.2013.01.003.

Cutter, C. N., Siragusa, G. R., 1994. Efficacy of organic acids against Escherichia coli O157:H7 attached to beef carcass tissue using a pilot scale model carcass washer. J. Food Prot. 57, 97-103. doi.org/10.4315/0362-028X-57.2.97.

Debeaufort, F., Quezada-Gallo, J. A., Voilley, A., 1998. Edible films and coatings: tomorrow's packaging: a review. Crit. Rev. Food Sci. 38, 299-313. doi.org/10.1080/10408699891274219.

Debnath, S., Ranade, R., Wunder, S. L., Baran, G. R., Zhang, J. M., Fisher, E. R., 2005. Chemical surface treatment of ultrahigh molecular weight polyethylene for improved adhesion to methacrylate resins. J. Appl. Polym. Sci. 96, 1564-72. doi.org/10.1002/app.21598.

Djagny, K. B., Wang, Z., Xu, S., 2001. Chemical modification of pigskin gelatin: factors affecting the esterification of gelatin with fatty acid. J. Food Sci. 66, 1326-1330. doi.org/10.1111/j.1365-2621.2001.tb15209.x.

Elshikh, M., Ahmed, S., Funston, S., Dunlop, P., McGaw, M., Marchant, R. and Banat, I.M., 2016. Resazurin-based 96-well plate microdilution method for the determination of minimum inhibitory concentration of biosurfactants. Biotechnol. Lett. 38, 1015-1019. doi.org/10.1007/s10529-016-2079-2.

Farris, S., Introzzi, L. and Piergiovanni, L., 2009. Evaluation of a bio-coating as a solution to improve barrier, friction and optical properties of plastic films. Pack. Technol. Sci. 22, 69-83. doi.org/10.1002/pts.826.

Farris, S., Unalan, LU., Introzzi, L., Fuentes-Alventosa, J. M. and Cozzolino, C. A., 2014. Pullulan-based films and coatings for food packaging: present applications, emerging opportunities, and future challenges. J. Appl. Polym. Sci. 131, 40539. doi.org/10.1002/app.40539.

Guilbert, S., Gontard, N., Gorris, L. G. M., 1996. Prolongation of the shelf-life of perishable food products using biodegradable films and coatings. LWT-Food Sci. Technol. 29, 10-17. doi.org/10.1006/fst1.1996.0002.

Guruvenket, S., Rao, G. M., Komath, M., Raichur, A. M., 2004. Plasma surface modification of polystyrene and polyethylene. Appl. Surf. Sci. 236, 278-84. doi.org/10.1016/j.apsusc.2004.04.033.

Hawkins, D. R., Rocabayera, X., Ruckman, S., Segret, R., Shaw, D., 2009. Metabolism and pharmacokinetics of ethyl Nα-lauroyl-L-arginate hydrochloride in human volunteers. Food Chem. Toxicol. 47, 2711-2715. doi.org/10.1016/j.fct.2009.07.028.

Hoferl, M., Buchbauer, G., Jirovetz, L., Schmidt, E., Stoyanova, A., Denkova, Z., . . . Geissler, M., 2009. Correlation of antimicrobial activities of various essential oils and their main aromatic volatile constituents. J. Essent. Oil Res. 21, 459-463. doi.org/10.1080/10412905.2009.9700218.

Hozumi, A., Inagaki, H., Kameyama, T., 2004. The hydrophilization of polystyrene substrates by 172-nm vacuum ultraviolet light. J. Colloid Interf. Sci. 278, 383-392. doi.org/10.1016/j.jcis.2004.06.005.

Kawamura, Y., Whitehouse, B., 2008. Chemical and technical assessment of ethyl lauryl arginate for the 69th JECFA. www.fao.org/3/a-at962e.pdf. Last accessed on Jul. 11, 2019.

Luchansky, J. B., Call, J. E., Hristova, B., Rumery, L., Yoder, L., Oser, A., 2005. Viability of Listeria monocytogenes on commercially-prepared hams surface treated with acidic calcium sulfate and lauric arginate and stored at 4° C. Meat Sci. 71, 92-99. doi.org/10.1016/j.meatsci.2005.04.006.

Mangalassary, S., Han, I., Rieck, J., Acton, J. And Dawson, P., 2008. Effect of combining nisin and/or lysozyme with in-package pasteurization for control of Listeria monocytogenes in ready-to-eat turkey bologna during refrigerated storage. Food Microbiol. 28, 866-870. doi.org/10.1016/j.fm.2008.05.002.

Manso, S., Nerin, C., Gomez-Lus, R., 2011. Antifungal activity of the essential oil of cinnamon (Cinnamomum zeylanicum), oregano (Origanum vulgare) and lauramide arginine ethyl ester (LAE) against the mold Aspergillus flavus CECT 2949. Ital. J. Food Sci. Technol. 23, 151-156.

Morsy, M. K., Khalaf, H. H., Sharoba, A. M., El-Tanahi, H. H. and Cutter, C. N., 2014. Incorporation of essential oils and nanoparticles in pullulan films to control foodborne pathogens on meat and poultry products. J. Food Sci. 79, M675-M684. doi.org/10.1111/1750-3841.12400.

Ng, C. M., Oei, H. P., Wu, S. Y., Zhang, M. C., Kang, E. T., Neoh, K. G., 2000. Surface modification of plasma-pretreated high-density polyethylene films by graft copolymerization for adhesion improvement with evaporated copper. Polym Eng Sci. 40, 1047-1055. doi.org/10.1002/pen.11232.

O'Connell, C., Sherlock, R., Ball, M. D., Aszalos-Kiss, B., Prendergast, U., Glynn, T. J., 2009. Investigation of the hydrophobic recovery of various polymeric biomaterials after 172 nm UV treatment using contact angle, surface free energy and XPS measurements. Appl. Surf. Sci., 255, 4405-4413. doi.org/10.1016/j.apsusc.2008.11.034.

Onyiriuka, E. C., 1993. The effects of high-energy radiation on the surface chemistry of polystyrene: A mechanistic study. J. Appl. Polym. Sci. 47, 2187-2194. doi.org/10.1002/app.1993.070471213.

Pattanayaiying, R., Aran, H., Cutter, C. N., 2014. Effect of lauric arginate, nisin Z, and a combination against several food-related bacteria. Int. J Food Microbiol. 188, 135-146. doi.org/10.1016/j.ijfoodmicro.2014.07.013.

Pattanayaiying, R., Aran, H., Cutter, C. N., 2015a. Incorporation of nisin Z and lauric arginate into pullulan films to inhibit foodborne pathogens associated with fresh and ready-to-eat muscle foods. Int. J Food Microbiol. 207, 77-82. doi.org/10.1016/j.ijfoodmicro.2015.04.045.

Pattanayaiying, R., Aran, H., Cutter, C. N., 2015b. Optimization of formulations for pullulan films containing lauric arginate and nisin Z. LWT-Food Sci. Technol. 63, 1110-1120. doi.org/10.1016/j.lwt.2015.04.016.

Rodriguez, E., Seguer, J., Rocabayera, X., Manresa, A., 2004. Cellular effects of monohydrochloride of L-arginine Na-lauroyl ethylester (LAE) on exposure to Salmonella Typhimurium and Staphylococcus aureus. J. Appl. Microbiol. 96, 903-912. doi.org/10.1111/j.1365-2672.2004.02207.x.

Sharifi-Rad, J., Salehi, B., Varoni, E. M., Sharopov, F., Yousaf, Z., Ayatollahi, S. A., Kobarfard, F., Sharifi-Rad, M., Afdjei, M. H., Sharifi-Rad, M., Iriti, M. (2017). Plants of the Melaleuca genus as antimicrobial agents: From farm to pharmacy. Phytother. Res. 31, 1475-1494. doi.org/10.1002/ptr.5880.

Silva, N. H., Vilela, C., Almeida, A., Marrucho, I. M., Freire, C. S., 2018. Pullulan-based nanocomposite films for functional food packaging: Exploiting lysozyme nanofibers as antibacterial and antioxidant reinforcing additives. Food Hydrocolloids, 77, 921-930. doi.org/10.1016/j.foodhyd.2017.11.039.

Singh, R. S., Kaur, N., Kennedy, J. F., 2019. Pullulan production from agro-industrial waste and its applications in food industry: a review. Carbohyd. Polym. 217, 46-57. doi.org/10.1016/j.carbpol.2019.04.050.

Siragusa, G. R., Cutter, C. N., Willett, J. L., 1999. Incorporation of bacteriocin in plastic retains activity and inhibits surface growth of bacteria on meat. Food Microbiol. 16, 229-235. doi.org/10.1006/fmic.1998.0239.

Temmerman, E., Akishev, Y., Trushkin, N., Leys, C., Verschuren, J., 2005. Surface modification with a remote atmospheric pressure plasma: dc glow discharge and surface streamer regime. J Physics D: Appl. Physics 38, 505. doi.org/10.1088/0022-3727/38/4/001.

Tharanathan, R.N. 2003. Biodegradable films and composite coatings: past, present and future. Trends Food Sci. Technol. 14, 71-78. doi.org/10.1016/50924-2244(02)00280-7.

The Target Group, Inc., 2012. Laurie arginate: a new active preservative derived from natural materials. www.foodsafetymagazine.com/articlePF.asp?id=4286&sub=sub1. Last accessed on Jul. 11, 2019.

Theinsathid, P., Visessanguan, W., Kruenate, J., Kingcha, Y., Keeratipibul, S., 2012. Antimicrobial activity of lauric arginate-coated polylactic acid film against Listeria monocytogenes and Salmonella Typhimurium on cooked sliced ham. J. Food Sci. 72, 142-149. doi.org/10.1111/j.1750-3841.2011.02526.x.

Trinetta, V., Cutter, C. N., Floros, J. D., 2011. Effects of ingredient composition on optical and mechanical properties of pullulan film for food-packaging applications. LWT-Food Sci. Technol. 44, 2296-2301. doi.org/10.1016/j.lwt.2011.07.015.

Trinetta, V., Floros, J. D., Cutter, C. N., 2010. Sakacin A-containing pullulan film: an active packaging to control epidemic clones of Listeria monocytogenes in ready-to-eat foods. J. Food Safety 30, 366-381. doi.org/10.1111/j.1745-4565.2010.00213.x.

### Part II

This Part II of the disclosure includes an analysis of the physical and mechanical properties laminated antimicrobial films (LAFs) incorporated with different concentrations of lauric arginate (LAE) as a natural antimicrobial substance to be used for vacuum packaging and other packaging methods that in non-limiting embodiments pertain to muscle foods. The disclosure includes each and every physical and mechanical property of the LAFs that are described herein. Part II expands Part I which demonstrated laminated antimicrobial films (LAFs) comprising pullulan (Pu) and polyethylene (PE) and incorporating different concentrations of LAE, nisin and thymol. Based on the minimum inhibitory and bactericidal concentrations of several combinations of these antimicrobials against four types of foodborne pathogens, LAE showed the most reliable results. LAFs with varying antimicrobial concentrations of LAE are made into food sachets/bags and evaluated for antimicrobial activity against fresh and further processed meat and poultry products that were experimentally-inoculated with foodborne pathogens and stored for up to 28 days at 4° C. LAFs containing 1 and 2.5% LAE successfully reduced: Shiga toxin-producing E. coli (STEC) on raw beef; Salmonella on raw chicken breast; Listeria monocytogenes on ready-to-eat (RTE) turkey breast and Staphylococcus aureus on RTE turkey breast from 1.33 to 3.56 log₁₀ CFU/cm². In this disclosure, the hydrophobicity and poor adhesive nature of polyethylene (PE) was altered by ultraviolet light exposure, allowing a Pu-based biopolymer containing LAE to attach to the PE surface, as illustrated in Part I. Part II comprises analysis of optical and mechanical characteristics of LAFs with various concentrations of LAE and comparison of them with commercial polyethylene (PE), thin and thick pullulan (Pu) films, and pullulan/polyethylene laminated films without LAE (Pu/PE) in terms of thickness (T), transparency (Tr), ultimate tensile strength (TS), elastic modulus (EM), elongation at break (EB), puncture resistance (PR), deformity at puncture (DP), and heat sealability. Additionally, the antimicrobial properties of LAFs containing LAE were determined in vitro using a disc diffusion assay (DDA) against four foodborne pathogens: Staphylococcus (Staph.) aureus, Listeria (L.) monocytogenes, Salmonella spp. and Shiga toxin producing E. coli (STEC).

### Part II Examples

The following materials and methods were used to obtain the results described in the Part II examples.

### Reagents

Pullulan (Pu) was obtained from Hayashibara Co., LTD. (Okayama, Japan). Glycerol ≥99.7% was obtained from VWR Company (Radnor, Pa., USA). Lauric arginate (LAE) (CytoGuard™) was obtained from A&B Ingredients, Inc. (Fairfield, N.J., USA). Xanthan gum, gelatin, and locust bean gum were obtained from Sigma Aldrich (St. Louis, Mo., USA).

### Preparation of Laminated Antimicrobial Films (LAFs)

The disclosure includes but is not limited to all of the following compositions of matter, all combinations thereof, and all steps, under this “Preparation of pullulan-based films” section of the disclosure.

LAFs comprising a sterile Pu-based biopolymer layer incorporating LAE and a PE layer were prepared as follows. The active biopolymer mixture containing LAE was made by combining Pu (150 g/L), gelatin (30 g/L), xanthan gum (2.5 g/L) and glycerol (30-70 mL/L) in sterile distilled water (DW), then adding LAE at concentrations of 0.5, 1.0 or 2.5% v/v according to the following procedure. DW was preheated on a hot plate adjusted to 90° C., gelatin added with stirring, followed by the addition of Pu, and then xanthan gum. The temperature was increased with continuous stirring until all ingredients were dissolved. Finally, glycerol was added as a plasticizer and to enhance adhesion to the PE. When all components were completely dissolved, the pH was adjusted to 8.5 using 1M NaOH. The mixture was autoclaved at 121° C. for 15 min and cooled to 55° C. before use. LAE solutions were filter sterilized (0.2 μm; Pall Acrodisc Syringe Filters; Port Washington, N.Y.) and mixed with the biopolymer solution to obtain the desired final concentrations.

Simultaneously, commercial polyethylene (PE; Ultravac Solutions LLC, Kansas City, Mo.) of 65-70 μm thickness was cut aseptically to pieces 20 cm×30 cm and subjected to ultraviolet (UV) light treatment in a biological safety hood (NuAire 6′ Class II Type A2 Biological Safety Cabinet, Plymouth, Minn.) to increase the surface energy and sterilize the surface of the PE film (Onyiriuka; 1993). The distance from the lamp was approximately 50 cm and the UV light wavelength was 254 nm. Approximately 25 mL of the autoclaved liquid biopolymer (55° C.) was poured directly onto the UV-treated side of PE film fixed on a piece of glass and spread using a Microm II micrometer film applicator (Paul N Gardner Company, Inc., Pompano Beach, Fla. USA) with a sterile stainless-steel blade of 15 cm width under aseptic conditions, resulting in a pullulan-based biopolymer coating layer thickness of 40-50 μm. The resulting laminated antimicrobial films (LAF/LAE 0.5%, LAF/LAE 1.0% or LAF/LAE 2.5%) were dried at 25° C. and 40% relative humidity for 24 h under a biological safety hood.

A control pullulan/polyethylene laminated (Pu/PE) film was prepared using Pu-based biopolymer mixture without LAE (0% LAE) using the same method of LAF as described above.

### Preparation of Pullulan-Based Films

The disclosure includes but is not limited to all of the following compositions of matter, all combinations thereof, and all steps, under this “Preparation of pullulan-based films” section of the disclosure.

Pullulan-based biopolymer films were made according to the optimized formulation developed by Trinetta et al. (2011) with slight modifications. Pu (100 g/L), locust bean (1 g/L), xanthan gum (1 g/L) and glycerol (10 mL/L) were dissolved in sterile distilled water (DW) as follows. DW was heated to 90° C. on a hot plate stirrer, Pu was added with stirring, followed by the addition of glycerol as a plasticizer, locust bean, and xanthan gum. The temperature was increased with stirring until all ingredients were dissolved. Finally, the mixture was autoclaved at 121° C. for 15 min. Approximately 25 mL of the liquid biopolymer (55° C.) was poured directly onto a clean glass plate and spread under aseptic conditions using a Microm II micrometer film applicator (Paul N Gardner Company, Inc., Pompano Beach, Fla. USA) with adjustable film thickness and a sterile stainless-steel blade of 15 cm width. Two films were prepared: 50±3 μm (thin Pu), which was similar in thickness to the biodegradable layer of LAF, and 115±3 μm (thick Pu), which was similar in thickness to that of LAF. Prepared Pu films were left to dry at 25° C. and 40% RH for 24 h under a biological safety hood, then stored aseptically at 25° C. until needed. Pieces of commercial PE film were prepared for comparison. All films were stored aseptically at 25° C. until needed for experiments.

### Mechanical Characterization

### Determination of Film Thickness (μm)

The thickness (T) of each film strip (μm) was measured with a micrometer (Max-Cal Inc., Japan) at 5 random points for each sample. At least 5 replicates were chosen for each film type.

Tensile strength (TS), Elongation at break (EB) and Elastic Modulus (EM)

The TS, EB and EM of each film type were determined using a TA-XT2i® texture analyzer (Texture Technologies Corp., New York, USA). Each film sample was cut into 1 cm×5 cm strips. At least 5 replicates were measured for each film type. The tests were evaluated according to ASTM Standard F88/F88M (ASTM, 2015). The initial grip separation was 20 mm, while the crosshead speed was 0.5 mm/s. The TS, EB and EM were calculated according to the following equations (1, 2 and 3, respectively):

TS=F/A=F/(WT) Equation (1)

EB=100×(ΔL/L) Equation (2)

EM=Stress/Strain=F/(WT)/(ΔL/L) Equation (3)

where W was the film width, T was the film thickness, F was the maximum force and A was the initial sample cross-section area (W×T). Where ΔL was the length of the sample at break and L was the original length of the sample.

### Puncture Resistance (PR) and Deformation at Puncture (DP) (mm)

The PR of each film type was determined by using a TA-XT2i® texture analyzer. A sample from each film type was secured in a TA-1085-5 small film extensibility rig and a ¼ inch hemispherical probe was pushed through the film at a rate of 0.2 mm/s. The area under the load-deformation curve up to the point of puncture (load at puncture, N) was determined as the puncture resistance (PR) and used to express film toughness (Lange, Mokdad, & Wysery, 2002; Trinetta et al., 2011). The deformity of the film up to the point of puncture was measured (mm) and used to express the deformation at puncture (DP).

### Transparency (Tr)

Film transparency (%) was determined using a spectrophotometer (Helios a, Thermo Spectronic, UK). The percent transmittance at 600 nm (Tm₆₀₀) was measured for each sample and the results were used for calculating the film transparency according to the equation (4) below (Jutaporn, Suphitchaya, & Thawien, 2011). For each film type, at least 5 replicates were measured.

$$Transparency = \frac{Log ( Tm 600 )}{T} \qquad Equation ( 4 )$$

where T was the average film thickness (mm) of the same sample.

### Sealability

Film samples were cut into 100×15 mm strips. Two film strips were placed on top of one another, with the Pu-based layers in contact in case of LAF. A two-mm sealing width at the edge of the two strips (15 mm length) was made using a 16-inch impulse heat sealer Model-FS-400 (Metronic, USA) at a temperature of 120-150° C. according to the type of film, and a sealing time of 3×0.9 s in case of thick films (LAFs/LAE and Pu/PE films), or 0.9 s in case of PE and Pu films. Before assessing seal strength manually, all sealed film samples were kept at 25±2° C. and 40% RH for 48 h. Sealability of the heat-sealed film strips was determined by hand peeling (Niimanee, Jinkarn, Jampan, Pisuchpen, & Yoxall, 2018) as follows. The end of one leg of the sealed strip was grasped in one hand and the end of the other leg was grasped in the other hand, in the way that the sealed strip was held perpendicular to the direction of pulling. The film samples that separated with minimal force of manual pulling were considered non-sealable, while those film samples that resisted separation were considered sealable. At least 10 replicates were used for each film type.

### Assessment of the Antimicrobial Properties of LAFs

The antimicrobial properties of LAFs containing different concentrations of LAE (0.5, 1.0 or 2.5%) were determined using a disc diffusion assay (DDA, Siragusa, Cutter & Willett, 1999). Laminated Pu/PE films with 0% LAE were used as controls. Foodborne bacterial pathogens (Table 8) were obtained from the Penn State Food Microbiology Culture Collection (University Park, Pa., USA) and were made into four individual cocktails for use in DDAs. Cocktails were made by aseptically adding equal amounts of overnight cultures (37° C. for 18 h) into a sterile test tube. All films were aseptically cut into rounded discs (5 mm in diameter) and placed onto the surface of Muller Hinton agar (Difco) plates that had been streaked with ca. 8 log₁₀ CFU/mL of each bacterial cocktail. In case of LAF, the discs were placed with the active Pu-based layer downward facing the plate surface. Plates were incubated at 37° C. for 24 h, zones of inhibition measured using a ruler, and areas (mm2) recorded.

### Statistical Analysis

Means and standard deviations of at least 3 replicate film preparations were calculated for each experiment. Significant differences and comparison among means were estimated using a one-way ANOVA with Tukey test for comparison of means (Minitab 18 statistical software). Means were considered significantly different if P<0.05.

Using the above described materials and methods, the following results were obtained.

### UV Light and Gelatin Improve the Adhesion of PE to Pullulan-Based Biopolymer Film

The nonpolar nature of polyethylene results in poor adhesion to polar surfaces and interfaces. Therefore, several approaches, including corona and plasma treatment, have been developed to change the surface properties of PE in order to enhance its hydrophilicity (Debnath et al., 2005; Guruvenket, Rao, Komath, & Raichur, 2004; Ng et al, 2000). However, these approaches require expensive technologies and may have negative environmental impacts (Farris et al., 2009). The present disclosure provides laminated antimicrobial films (LAF) made from a PE layer coated with a Pu-based biopolymer layer containing LAE. To increase the surface energy and adhesion of PE to the biopolymer layer, one surface was treated by exposure to UV light (254 nm) in a biological safety hood for about 1 h, after which the biopolymer layer containing different concentrations of LAE was applied to the exposed side of the PE. Onyiriuka (1993) reported that the exposure of polystyrene to a 254 nm UV light led to surface oxidation of the polymer to depths greater than 10 nm as compared to around 3 nm depth offered by either plasma or corona-discharge treatment. Without intending to be bound by any particular theory, it is considered that the present disclosure provides the first description of active films made from a pullulan-based biopolymer adhered to polyethylene.

Also, gelatin was a useful component added to enhance the adhesion of Pu-based biopolymer layer to PE. It was added to the biopolymer mixture in case of LAF. These properties of gelatin can be attributed to its chemical nature, which includes the existence of functional groups such as carboxylic acid (COOH), hydroxyl (OH) and amino (NH₂) on its molecular backbone (Kim & Ustunol, 2001; Schrieber & Gareis, 2007).

### Film Thickness and Transparency

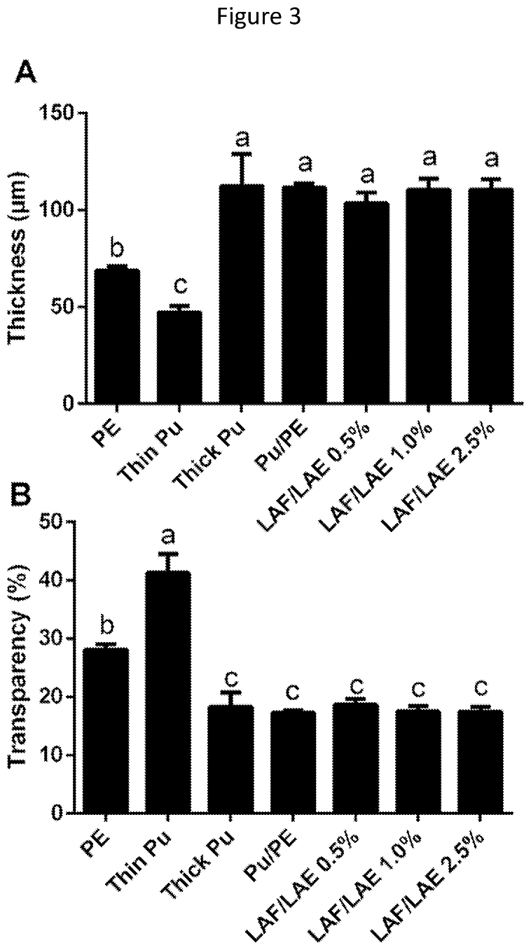

Film thickness affects most of the functional properties of a packaging system. Cuq, Gontard, Cuq, & Guilbert (1996) reported an indirect relationship between the thickness of cellulose-based coatings and the degree of release of their active molecules. We compared the thickness and transparency of LAFs made with LAE (0.5, 1.0 or 2.5%) to samples of commercial PE, Pu (thin and thick), and control Pu/PE films without LAE (FIG. 3). Thin Pu films at 47 μm and commercial PE film at 69 μm were significantly thinner than other films (p<0.05). There were no significant differences among thick Pu, Pu/PE, or LAF/LAE films in terms of thickness, which ranged from 103 to 110 μm (FIG. 3A). Thick Pu film (112.2 μm) consisted entirely of the biodegradable biopolymer, while each of Pu/PE film and LAFs were comprised of two layers (active biodegradable biopolymer and inert polyethylene); thus, the thickness of the active biopolymer layer ranged from 34-45 μm, which is similar to that of thin Pu film.

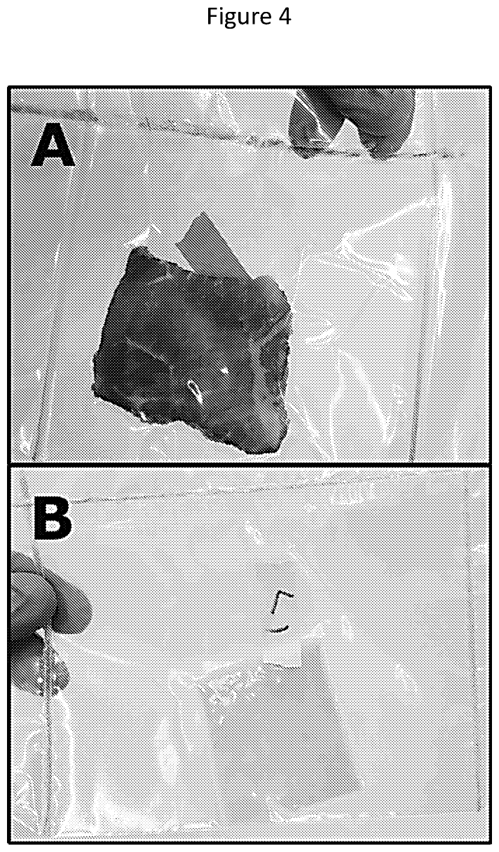

Transparency can be related to film thickness. Mali, Grossmann, & Garcya (2004) demonstrated that an increase in film thickness causes an increase in film opacity; conversely, thicker films can exhibit better mechanical properties (Cuq et al., 1996). Similarly, in this disclosure, we demonstrate a negative correlation between thickness and transparency of films (r=−0.978). Thin Pu films demonstrated the highest transparency, followed by PE (p<0.05). Thick Pu, Pu/PE, and LAF/LAE films were quite similar to each other in transparency, but significantly lower (p<0.05) than both PE and thin Pu films (FIG. 3B). However, they were still transparent enough to see through (FIG. 4).

### Mechanical Properties of Films

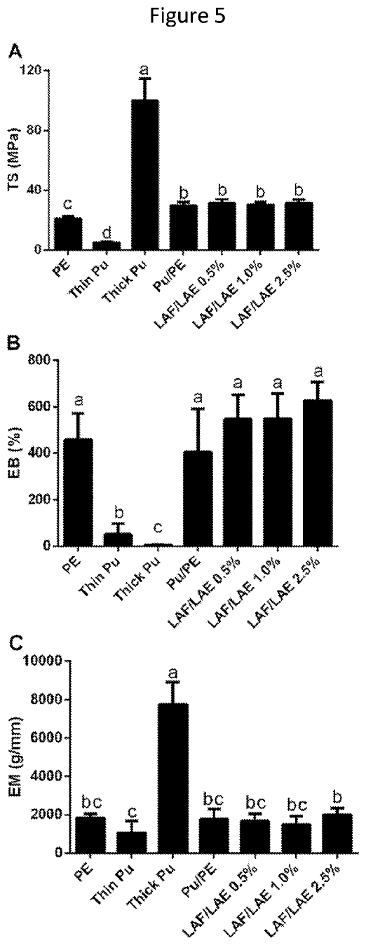

Mechanical properties are important in evaluating new types of food packaging, especially for durability, strength and resistance to environmental conditions during food transportation, storage, and display. Thin Pu film demonstrated the lowest TS, followed by PE, the LAFs, and finally thick Pu (FIG. 5A). Pu films, both thin and thick, were less compliant, i.e. had lower EB, than either PE or LAF (FIG. 5B), and the EM was essentially the same for all films with the exception of thick Pu, which was significantly greater than the rest (p<0.05) (FIG. 5C). Thick Pu demonstrated an EB of only 5.8%, which made this film highly rigid, inflexible, unbendable and easily broken with a minimal degree of stretching. Conversely, thin Pu films were 8.8-fold the EB value of thick films; however, they were not strong enough to resist stretching. The bonding of PE with Pu into a laminated film significantly increased the EB of these films relative to Pu films (p<0.05). There appeared to be a direct relationship between the concentration of LAE in LAFs and EB values (r=0.829), suggesting that LAE plasticized these films.

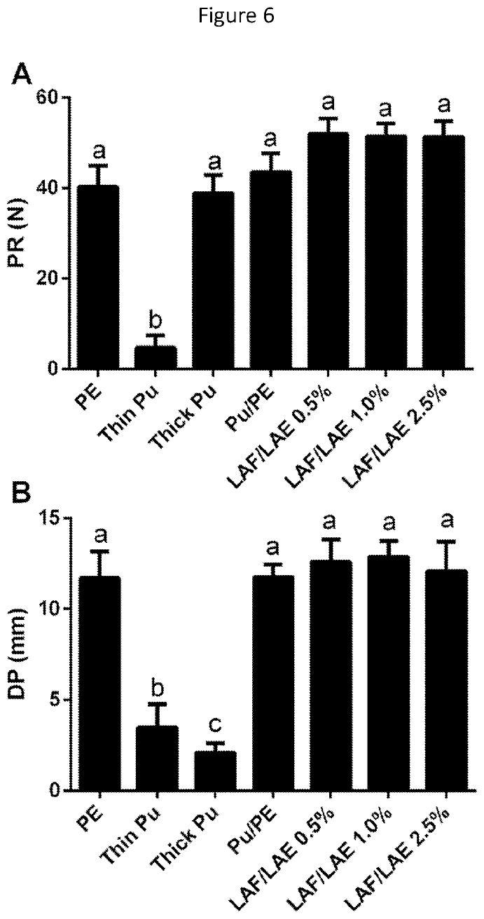

The results for puncture resistance (PR) and deformation at puncture (DP) for the films are presented in FIG. 6. Thin Pu films exhibited the lowest average PR (4.68 N) (p<0.05), illustrating their lack of toughness. On the other hand, all other films displayed high resistance to puncture (FIG. 6A). The average value of DP for thick Pu films was 2.1 mm, demonstrating the rigidity and inflexibility of this film. DP of thin Pu film (3.5 mm) was 1.5 times higher than that of thick Pu, although still brittle and easily punctured. PE film is commonly used for food packaging due to its acceptable mechanical properties. By laminating PE and the Pu-based films PR and DP were increased to practical values. Since TS and PR determine the physical strength of films, while EB and DP determine the flexibility and stretchability, a direct relationship between the TS and PR (r=0.275) and between EB and DP (r=0.968) was observed (FIGS. 5 & 6).

We found that incorporating nisin and thymol in LAFs resulted in very brittle laminates that ultimately failed to adhere to PE, which could be attributed to the effect of the diluents (HCl and ethanol, respectively). Thus, in embodiments, the disclosure relates to LAFs with LAE, which is soluble in water. Interestingly, a relationship between the concentration of LAE and the adhesion of the biopolymer layer to PE was observed. High LAE concentrations negatively affected the adherence of the biopolymer layer to PE. To overcome this, the concentration of glycerol was adjusted, allowing for adherence of the Pu-based biopolymer layer to PE. Said change in use of glycerol is encompassed the disclosure. Consequently, control Pu/PE/LAE 0%, LAF/LAE 0.5%, LAF/LAE 1.0% or LAF/LAE 2.5% required 3, 5, 6 and 7 mL of glycerol/100 mL DW (v/v), respectively for proper adhesion. LAFs/LAE with lower concentrations of glycerol (<3%), as previously recommended by Pattanayaiying et al. (2015b) and Trinetta et al. (2011) in pullulan-LAE/nisin films (2.5 and 10 g/L, respectively), were brittle and easily detached from the PE. Additionally, pullulan films made with LAE and comprising higher concentrations of glycerol (>7%) were very viscous and sticky, which made them difficult to work with and not suitable for the currently described purposes. Glycerol serves as a plasticizer, making films flexible, reducing brittleness, and increasing flexibility (Bourtoom, 2008; McHugh & Krochta, 1994; Trinetta et al., 2011). On the other hand, Pattanayaiying et al. (2015b) stated that increasing glycerol concentration lead to a decrease in TS and EM and an increase EB in pullulan/LAE films, while this effect of glycerol was not noticeable in pullulan/LAE-nisin Z films. In an embodiment, a concentration of glycerol of less than 7% is used. In a non-limiting embodiment, 2.4% of glycerol is used.

### Heat Sealability of Films

Sealability is another factor that influences the suitability for standalone packaging material. To be useful as an antimicrobial, the Pu layer of the LAFs should face inward toward the food product. Therefore, we measured film sealability with the antimicrobial layers facing each other. The sealing strength of both thin Pu and thick Pu films was weak and did not resist minimal peeling tension. However, PE and surprisingly Pu/PE and LAFs were heat-sealable, at 120° C./0.9 s, 120° C./2.7 s and 150° C./2.7 s, respectively. Pu/PE and LAFs, due to their greater thickness and the biopolymer layer, required higher sealing temperatures and longer sealing duration. These results confirm that LAFs can be used for making bags or sachets for vacuum food packaging without the need for extra support (FIG. 4). Films could also be folded in a manner such that the seal was formed between PE layers while still exposing the interior of the package to the antimicrobial layer. The sealability of LAFs containing LAE can be attributed to both the heat sealable PE layer and the incorporation of gelatin in the Pu-based biopolymer layer.

### Antimicrobial Activity of LAFs

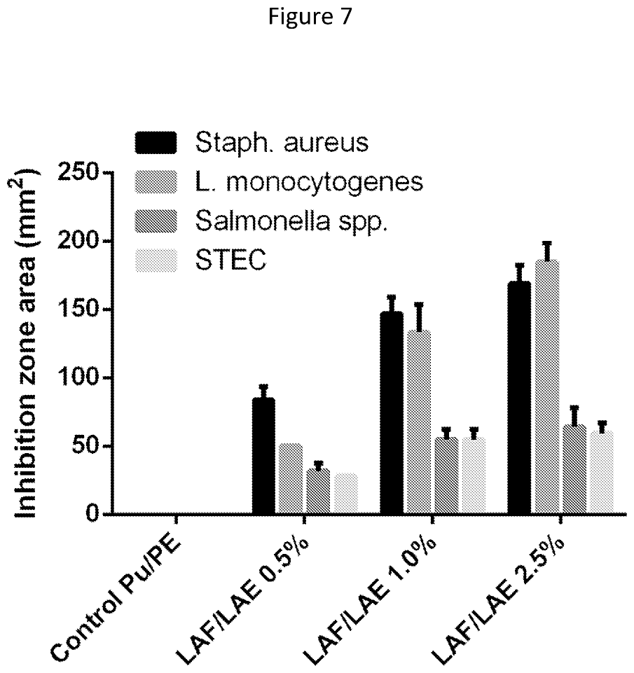

Disc diffusion assays were conducted to evaluate the antimicrobial properties of LAF containing 0.5, 1.0 or 2.5% (v/v) of LAE and control Pu/PE films (0% LAE) against two Gram-positive and two Gram-negative foodborne pathogens (i.e., S. aureus, L. monocytogenes, Salmonella spp. and STEC). Zones of inhibition (mm²) are presented in FIG. 7. There were direct relationships between the concentration of LAE in LAF and zones of inhibition as positive correlation coefficients were reported with r values ranged between 0.84 to 0.94. However, there were no significant differences (p>0.05) between the inhibition by LAF/LAE 1.0% and LAF/LAE 2.5% against the pathogens, except for L. monocytogenes, where LAF/LAE 2.5% resulted in significantly larger zones of inhibition. The efficacy of LAF/LAE 1.0% and LAF/LAE 2.5% was significantly higher than that of LAF/LAE 0.5% (p<0.05). The antimicrobial efficacy of LAFs containing LAE was significantly greater against S. aureus and L. monocytogenes than against Salmonella spp. and STEC. Control Pu/PE films did not inhibit any bacterial cultures. LAE is a generally recognized as safe compound (GRAS) by the U.S. Food and Drug Administration (FDA) and is approved as a food preservative by the European Food Safety Authority (EFSA) (Kawamura and Whitehouse, 2008). In embodiments, one or more components of the described materials are GRAS component(s).

TABLE 8
Bacterial cultures used in disk diffusion assays (DDAs).
Cocktails were made from equal
amounts of each culture after growth (37° C., 18 h).

| | Shiga | | | |
|---|---|---|---|---|
| | toxin- | | | |
| | producing | | | |
| | E. coli | Salmonella | Listeria | |
| Foodborne | (STEC) | spp. | monocytogenes | Staphylococcus |
| pathogens | cocktail | cocktail | cocktail | aureus cocktail |
| Strains | E. coli | S. | L. | S. aureus |
| | O157:H7 | Typhimurium | monocytogenes | ATCC |
| | ATCC^{a} | CDC^{b} ST4 | FSL^{c} J1-003 | 13565 |
| | 43895 | | | |
| | E. coli | S. Entertidis | L. | S. aureus |
| | O145 | CDC SE29 | monocytogenes | ATCC |
| | ATCC 2192 | | FSL J2-685 | 27154 |
| | E. coli | S. Saintpaul | L. | S. aureus |
| | O111 | CDC SS34 | monocytogenes | ATCC |
| | ATCC | | FSL J1-129 | 27664 |
| | 43877 | | | |

^{a}American Type Culture Collection (ATCC; Manassas, VA)
bCenters for Disease Control and Prevention (CDC; Atlanta, GA)
^{c}Food Safety Lab (FSL; Cornell University, Ithaca, NY)

Accordingly, as described above, although previously available biodegradable pullulan films have several advantages as packaging materials, they lack the necessary mechanical characteristics in terms of tensile strength and flexibility. Thin Pu films were very brittle and exhibited minimal tensile strength, while thick Pu films were very rigid and inflexible. Additionally, pullulan films were not heat-sealable, so extra outer packaging is essential for physical support and sealability. We have demonstrated that a laminated antimicrobial film (LAF) made with a pullulan-based biopolymer containing lauric arginate and adhered to UV-treated polyethylene, exhibited excellent optical and mechanical properties, including transparency, tensile strength, elastic modulus, elongation at break, puncture resistance, deformity at puncture, and heat sealability. LAFs containing LAE at 1.0 or 2.5% (v/v) demonstrated broad-spectrum antimicrobial activity against foodborne pathogens, with Gram-positive bacteria being more susceptible to the compound than Gram-negative bacteria.

It will also be recognized from the foregoing description, examples, and the figures, that the disclosure provides a characterization of CAFs performed by comparison with bare commercial polyethylene films (PE), biodegradable pullulan-based films (Pu) and control Pu/PE composite, in terms of thickness (T), ultimate tensile strength (TS), elastic modulus (EM), elongation at break (EB), puncture resistance (PR) and deformity at puncture (DP), as well as heat-sealability and transparency. Thin Pu films had lowest thickness (47 μm), followed by PE (69 μm) (p<0.05), while there were no significant differences in terms of thickness between thick Pu, Pu/PE, CAF/LAE 0.5%, CAF/LAE 1.0% and CAF/LAE 2.5%, which ranged from 103 to 110 μm. Transparency % showed the opposite of thickness, thin Pu films showed the highest significant transparency % (p<0.05), followed by commercial PE, whereas thick Pu, Pu/PE, CAF/LAE 0.5%, CAF/LAE 1.0% and CAF/LAE 2.5% were significantly lower than others (p<0.05). Regarding the physical and mechanical properties, thin Pu films were very brittle and did not resist minimal physical tension, while thick Pu films are very rigid, inelastic and breakable. Conversely, the successful merging of Pu with PE in one composite such as in CAF/LAE, significantly improved the tensile strength and elasticity (in terms of TS, EM, EB, PR and DP). Furthermore, CAF/LAE was transparent and heat sealable. Thus, the significant reduction of foodborne pathogens associated with muscle foods using vacuum packaging bags made from CAF/LAE 2.5% supports the utility of using materials of the disclosure in food packaging. CAF/LAE 2.5 has as advantages the following: lower cost, time and steps necessary for packaging of foods wrapped with biodegradable films.

It will also be recognized from the foregoing that the present disclosure demonstrates in part that pullulan-based films described herein have several advantages over previously available technologies, namely, biodegradability, edibility, recyclability, and the ability to be incorporated with antimicrobials. Previously available technologies lack the necessary physical and mechanical strength in terms of tensile strength and elasticity. Thin Pu films are very brittle and do not resist minimal physical tension, while thick Pu films are very rigid, inelastic and breakable. On the other hand, CAFs made from pullulan-based layer and PE layer as described herein, particularly when incorporated with LAE as antimicrobial, successfully passed the physical and mechanical evaluation tests including TS, EM, EB, PR and DP, were transparent enough to see the contents, and are heat sealable.

References for Part II—This reference listing is not an indication that any particular reference is material to patentability.

ASTM (2015). Standard Test Method for Seal Strength of Flexible Barrier Materials F88/F88M-2015, in: Annual book of ASTM standards, Philadelphia, Pa.

Bakal, G. & Diaz, A. (2005). The lowdown on lauric arginate: food antimicrobial hammers away at plasma membrane, disrupting a pathogen's metabolic process. Food Quality, 12, 54-61.

Bourtoom, T. (2008). Plasticizer effect on the properties of biodegradable blend film from rice starch-chitosan. Songklanakarin Journal of Science and Technology, 30, 149e165.

Cuq, B., Gontard, N., Cuq, J. L., & Guilbert, S. (1996). Functional properties of myofibrillar protein-based biopackaging as affected by film thickness. Journal of Food Science, 61, 580e584. doi.org/10.1111/j.1365-2621.1996.tb13163.x.

Debeaufort, F., Quezada-Gallo, J. A., & Voilley, A. (1998). Edible films and coatings: tomorrow's packagings: a review. Critical Reviews in Food Science, 38(4), 299-313. doi.org/10.1080/10408699891274219.

Debnath, S., Ranade, R., Wunder, S. L., Baran, G. R., Zhang, J., & Fisher, E. R. (2005). Chemical surface treatment of ultrahigh molecular weight polyethylene for improved adhesion to methacrylate resins. Journal of applied polymer science, 96(5), 1564-1572. doi.org/10.1002/app.21598.

Djagny, K. B., Wang, Z., & Xu, S. (2001). Chemical modification of pigskin gelatin: Factors affecting the esterification of gelatin with fatty acid. Journal of food science, 66(9), 1326-1330. doi.org/10.1111/j.1365-2621.2001.tb15209.x.

Farris, S., Introzzi, L., & Piergiovanni, L. (2009). Evaluation of a bio-coating as a solution to improve barrier, friction and optical properties of plastic films. Packaging Technology and Science: An International Journal, 22(2), 69-83. doi.org/10.1002/pts.826.

FDA, 2005. GRAS Notice No. GRN 000164. Non-objection Letter from FDA. September 2005.

Guilbert, S., Gontard, N., & Gorris, L. G. (1996). Prolongation of the shelf-life of perishable food products using biodegradable films and coatings. LWT-food science and technology, 29(1-2), 10-17. doi.org/10.1006/fst1.1996.0002.

Guruvenket, S., Rao, G. M., Komath, M., & Raichur, A. M. (2004). Plasma surface modification of polystyrene and polyethylene. Applied surface science, 236(1-4), 278-284. doi.org/10.1016/j.apsusc.2004.04.033.

Jutaporn, C. T., Suphitchaya, C., & Thawien, W. (2011). Antimicrobial activity and characteristics of edible films incorporated with Phayom wood (Shorea tolura) extract. International Food Research Journal, 18, 39e54.

Kawamura, Y., Whitehouse, B., 2008. Chemical and technical assessment of ethyl lauryl arginate for the 69th JECFA. www.fao.org/3/a-at962e.pdf. Last accessed on Aug. 20, 2019.

Kim, S. J. & Ustunol, Z. (2000. Thermal properties, heat sealability and seal attributes of whey protein isolate/lipid emulsion edible films. Journal of food science, 66(7), 985-990. doi.org/10.1111/j.1365-2621.2001.tb08223.x.

Lange, J., Mokdad, H,, & Wysery, Y. (2002), Understanding puncture resistance and perforation behavior of packaging laminates. Journal of Plastic Film & Sheeting, 18(4), 231-244. doi.org/10.1177/8756087902033865.

Luchansky, J. B., Call, J. E., Hristova, B., Rumery, L., Yoder, L., & Oser, A. (2005). Viability of Listeria monocytogenes on commercially-prepared hams surface treated with acidic calcium sulfate and lauric arginate and stored at 4 C. Meat Science, 71(1), 92-99. doi.org/10.1016/j.meatsci.2005.04.006.

Mali, S., Grossmann, M. E., & Garcya, M. A. (2004). Barrier, mechanical and optical properties of plasticized yam starch films. Carbohydrate Polymers, 56, 129e135. doi.org/10.1016/j.carbpol.2004.01.004.

McHugh, T. H., & Krochta, J. M. (1994). Sorbitol- vs glycerol-plasticized whey protein edible films: integrated oxygen permeability and tensile property evaluation. Journal of Agriculture and Food Chemistry, 42, 841e845. doi.org/10.1021/jf00040a001.

Nafchi, A. M., & Alias, A. K. (2013). Mechanical, barrier, physicochemical, and heat seal properties of starch films filled with nanoparticles. In Journal of Nano Research (Vol. 25, pp. 90-100). Trans Tech Publications Ltd. doi.org/10.4028/www.scientific.net/JNanoR.25.90.

Ng, C, M. Oei, H. P., Wu, S, Y., Zhang, M, C., Kang, E. T., & Neoh, K. G. (2000). Surface modification of plasma-pretreated high density polyethylene films by graft copolymerization for adhesion improvement with evaporated copper. Polymer Engineering & Science, 40(5), 1047-1055. doi.org/10.1002/pen.11232.

Nilmanee, S., Jinkarn, Jarupan, L., Pisuchpen, S., & Yoxall, A. (2018). Seal strength evaluation of flexible plastic films by machine testing and human peeling. Journal of Testing and Evaluation, 46(4), 1508-1517. doi.org/10.1520/JTE20160541.

Onyiriuka, E. C. (1993). The effects of high-energy radiation on the surface chemistry of polystyrene: A mechanistic study. Journal of applied polymer science, 47(12), 2187-2194. doi.org/10.1002/app.1993.070471213.

Pattanayaiying, R., Aran, H., & Cutter, C. N. (2014). Effect of lauric arginate, nisin Z, and a combination against several food-related bacteria. International journal of food microbiology, 188, 135-146. doi.org/10.1016/j.ijfoodmicro.2014.07.013.

Pattanayaiying, R., Aran, H., &. Cutter, C. N. (2015a). Incorporation of nisin Z and lauric arginate into puflulan films to inhibit foodborne pathogens associated with fresh and ready-to-eat muscle foods. International Journal of Food Microbiology, 207, 77-82. doi.org/10.1016/j.ijfoodmicro.2015.04.045.

Pattanayaiying, R., Aran, H., & Cutter, C. N. (2015b). Optimization of formulations for pullulan films containing lauric arginate and nisin Z. LWT-Food Science and Technology, 63(2), 1110-1120. doi.org/10.1016/j.1wt.2015.04.016.

Petersen, K., Nielsen, P. V., Bertelsen, G., Lawther, M., Olsen, M. B., Nilsson, N. H., & Mortensen, G. (1999). Potential of biobased materials for food packaging. Trends in food science & technology, 10(2), 52-68. doi.org/10.1016/S0924-2244(99)00019-9.

Rodriguez, E., Seguer, J., Rocabayera, X., & Manresa, A. (2004). Cellular effects of rnonohydrochloride of 1-arginine, Nα-lauroyl ethylester (LAE) on exposure to Salmonella typhimurium and Staphylococcus aureus. Journal of Applied Microbiology, 96(5), 903-912. doi.org/10.1111/j.1365-2672.2004.02207.x.

Schrieber, R., & Gareis, H. (2007). Gelatine handbook: theory and industrial practice. John Wiley & Sons.

Siragusa, G. R., Cutter, C. N., Willett, J. L., 1999. Incorporation of bacteriocin in plastic retains activity and inhibits surface growth of bacteria on meat. Food Microbiol. 16, 229-235. doi.org/10.1006/fmic.1998.0239.

Tharanathan, R. N. (2003). Biodegradable films and composite coatings: past, present and future. Trends in food science & technology, 14(3), 71-78. doi.org/10.1016/S0924-2244(02)00280-7.

The Target Group, Inc. (2012). Lauric arginate: a new active preservative derived from natural materials.

Trinetta, V., Cutter, C. N., & Floros, J. D. (2011). Effects of ingredient composition on optical and mechanical properties of puilulan film for food-packaging applications. LWT-Food Science and Technology, 44(10), 2296-2301, doi.org/10.1016/j.lwt.2011.07.015.

Trinetta, V., Floros, J. D., & Cutter, C. N. (2010). Sakacin a-containing pullulan an active packaging system to control epidemic clones of Listeria monocytogenes in readd-to-eat foods. Journal of Food Safety, 30(2), 366-381. doi.org/10.1111/j.1745-4565.2010.00213.x.

USDA, 2005. USDA Letter of Approval to Use Lauric Arginate in meat and poultry products (September 2005).

1. An antimicrobial material for use in food packaging, the antimicrobial material comprising:
i) a first layer comprising one or more polysaccharides or polysaccharide biopolymers comprising an effective amount of at least one antimicrobial agent; and
ii) a second layer comprising a polyethylene or a chitosan, wherein at least a portion of the first layer is disposed on at least a portion of the second layer.

2. The antimicrobial material of claim 1, wherein the second layer comprising the polyethylene is present.

3. The antimicrobial material of claim 1, wherein the at least one antimicrobial agent is lauric arginate (LAE).

4. The antimicrobial material of claim 1, wherein the at least one antimicrobial agent comprises the LAE.

5. The antimicrobial material of claim 1, wherein i) comprises pullulan (Pu).

6. The antimicrobial material of claim 1, wherein ii) comprises the polyethylene.

7. The antimicrobial material of claim 1, wherein the i) comprises the Pu, and ii) comprises the layer comprising the polyethylene.

8. The antimicrobial material of claim 1, wherein the antimicrobial agent comprises the LAE, i) comprises the Pu, and ii) comprises the polyethylene.

9. The antimicrobial material of claim 1, wherein the first layer is adhered to the second layer, and/or wherein the first layer, the second layer, or both the first and second layers comprise a film.

10. The antimicrobial material of claim 9, wherein at least a portion of the first layer is in contact with a food product.

11. The method of claim 10, wherein growth of bacteria on the food product is inhibited or reduced.

12. The antimicrobial material of claim 11, wherein the food product comprises a muscle meat.

13. The antimicrobial material of claim 12, wherein the growth of the bacteria is inhibited for a period of at least 14 days under refrigeration conditions.

14. A method of making an antimicrobial material for use in food packaging, the method comprising:
a) combining at least one antimicrobial agent with one or more polysaccharides or polysaccharide biopolymers such that an amount of the antimicrobial agent is present in the one or more polysaccharides or polysaccharide biopolymers, the amount comprising an amount effective to inhibit growth of bacteria on a food product, to form an antimicrobial composition for forming a first layer in the antimicrobial material; and
b) contacting the antimicrobial composition of a) with a second layer comprising a polyethylene or a chitosan; to thereby form an antimicrobial material comprising the first layer and the second layer for use in the food packaging.

15. The method of claim 14, wherein the second layer comprises the polyethylene.

16. The method of claim 14, wherein the at least one antimicrobial agent is lauric arginate (LAE).

17. The method of claim 16, wherein the one or more polysaccharides or polysaccharide biopolymers comprises comprises pullulan (Pu).

18. The method of claim 16, wherein the second layer is subjected to ultraviolet radiation prior to contacting the antimicrobial composition of a) with the second layer.

19. The method of claim 14, wherein the second layer comprises the polyethylene, wherein the at least one antimicrobial agent is the (LAE), and wherein the one or more polysaccharides or polysaccharide biopolymers comprises comprises pullulan the Pu.

20. The method of claim 19, further comprising applying the antimicrobial material comprising the first layer and the second layer to a food product.

21. A method of increasing the shelf life of a food product and/or inhibiting growth of bacteria in the food product comprising:
packaging the food product with an antimicrobial material comprising i) a first layer comprising one or more polysaccharides or polysaccharide biopolymers comprising an effective amount of at least one antimicrobial agent; and
ii) a second layer comprising a polyethylene or a chitosan.

22. The method of claim 21, wherein the antimicrobial material comprises:
i) a first layer comprising one or more polysaccharides or polysaccharide biopolymers comprising an effective amount of at least one antimicrobial agent; and
ii) a second layer comprising a polyethylene or a chitosan,
wherein at least a portion of the first layer is disposed on at least a portion of the second layer.

23. The method of claim 21, wherein the antimicrobial material is made according to a method comprising:
a) combining at least one antimicrobial agent with one or more polysaccharides or polysaccharide biopolymers such that an amount of the antimicrobial agent is present in the one or more polysaccharides or polysaccharide biopolymers, wherein the amount of the antimicrobial agent is effective to inhibit growth of bacteria on a food product, to form an antimicrobial composition for forming a first layer in the antimicrobial material; and
b) contacting the antimicrobial composition of a) with a second layer comprising a polyethylene or a chitosan; to thereby form an antimicrobial material comprising the first layer and the second layer for use in the food packaging.

24. An antimicrobial material for use in food packaging made according to the method of claim 14.

25. The antimicrobial material of claim 24, wherein the antimicrobial material is in the form of a sheet or a bag.
